(19) United States
(12) Patent Application Publication
(10) Pub. No.: US 2017/0053319 A1
(43) Pub. Date: Feb. 23, 2017

(54) METHOD AND SYSTEM FOR ENABLING, MAXIMIZING AND PROLIFERATING THE ENDORSEMENT OF TRANSACTIONS UTILIZING SOCIAL MEDIA AND INCENTIVES TO DRIVE USER ENGAGEMENT

(71) Applicant: Zaptitude, LLC, Morristown, NJ (US)

(72) Inventor: Daniel D. Lynn, Flemington, NJ (US)

(21) Appl. No.: 15/343,476

(22) Filed: Nov. 4, 2016

Related U.S. Application Data
(63) Continuation of application No. 14/174,017, filed on Feb. 6, 2014.
Application No. 14/174,017 is a continuation of application No. 14/174,107, filed on Feb. 6, 2014.
Application No. 14/174,107 is a continuation of application No. 14/860,745, filed on Sep. 22, 2015.
(60) Provisional application No. 61/762,443, filed on Feb. 8, 2013.
(60) Provisional application No. 61/893,674, filed on Oct. 21, 2013.
(60) Provisional application No. 61/762,443, filed on Feb. 8, 2013.
(60) Provisional application No. 61/893,674, filed on Oct. 21, 2013.
(60) Provisional application No. 62/053,550, filed on Sep. 22, 2014.

(51) Int. Cl. G06Q 30/02; G06Q 50/00

(52) U.S. Cl. CPC G06Q 30/0269; G06Q 30/0246; G06Q 50/01

(57) ABSTRACT

Systems and methods directed generally towards capturing, tracking, and incentivizing customer endorsements at a point of interaction or transaction and monitoring and facilitating the spreading of that endorsement through the customer's social media channels in an effort to influence the purchase or transaction decisions of that customer's social media connections and the connections of their connections and so on.

### CROSS REFERENCE TO RELATED APPLICATIONS

The present application is a 1) Continuation of U.S. Nonprovisional application Ser. No. 14/174,017 filed 6 Feb. 2014, which claims the benefit of U.S. Provisional Application No. 61/762,443 filed 8 Feb. 2013 and U.S. Provisional Application No. 61/893,674 filed 21 Oct. 2013; and is a 2) Continuation of U.S. Nonprovisional application Ser. No. 14/174,107 filed 6 Feb. 2014, which claims the benefit of U.S. Provisional Application No. 61/762,443 filed 8 Feb. 2013 and U.S. Provisional Application No. 61/893,674 filed 21 Oct. 2013; and is a 3) Continuation of U.S. Nonprovisional application Ser. No. 14/860,745 filed 22 Sep. 2015, which claims the benefit of U.S. Provisional Application No. 62/053,550 filed 22 Sep. 2014; each of which is fully incorporated by reference herein in their entirety for all purposes.

### BACKGROUND

The present disclosure is directed generally toward systems and methods of capturing existing customer endorsements at the point of any purchase or transaction and spreading the endorsement through the customer's social media channels to influence the purchase or transaction decisions of that customer's social media connections and the connections of their connections and so on. More specifically, the present disclosure utilizes a customer's influence within social networks to drive additional brand awareness, brand engagement, transactions, and revenue for any organization.

As social media and online connectivity becomes more and more available, the amount of information users wish to share with their “friends” is ever increasing. Advances in the internet and mobility has made it possible for a user to share their real world experiences through their social media connections in ways as never before imagined.

There are essentially three layers of the Internet. Layer One (the foundation layer) consists of the backbone network that makes up the Internet and is comprised of the broad interconnection of hardware and networking equipment. Layer Two (the application layer) consists of the many software applications that have been developed by individuals and companies throughout the world to leverage the possibilities of the underlying foundation layer or to make that layer more usable. This includes static websites, dynamic tools, and Web 2.0 applications such as social media channels. Layer Three, creates an opportunity for brand new technologies to be invented that sit on top of the applications in Layer Two and help to integrate those applications and enable them to drive greater value for consumers and organizations. This layer may also integrate offline and online worlds for consumers and organizations—creating a more seamless customer experience. The present disclosure operates at this third layer.

The expansive and instant reach of the average consumer via their social networks creates a significant, untapped opportunity for organizations of all sizes to leverage the influence of existing customers to drive new customers. The present invention takes advantage of these untapped influences and discloses a hardware and software technology platform that is dedicated to helping organizations and businesses capture these new opportunities.

The described system technology platform can create significant and measurable value for an organization by providing a vehicle to create broader brand awareness and drive greater brand engagement. The system enables the organization to use social media more effectively as a new conversion channel, allows them to optimize that channel, and then let's them measure the results of that lift in conversion in real-time. The system may be used in both for-profit and non-profit environments.

The implementer of the system may host the platform or may employ others to host the system. As an implementer of the system a fee for providing increased value to an organization utilizing the service may be charged. This fee can include but not be limited to a performance fee, a percent of sales fee, a flat recurring fee, and/or a licensing fee. Social network providers may also use the system to monetize their user databases and imbedded user base. Social networking providers presently are developing marketing and advertising concepts that directly target their user base to monetize that base. In addition, they are directly targeting organizations to sell them advertising space. And, some do provide organizations with the ability to allow their end users to endorse an organization or a product on an organization's website. However, they don't provide those organizations with an integrated application that engages a user at the point of any transaction (whether online or offline), motivates that user to create an endorsement, facilitates the proliferation of that endorsement via the user's multiple social media networks, measures the ripple effect of the sharing, and provides a set of tools to continually improve and optimize the results. A significant opportunity for them would be to utilize the present system, such that, instead of targeting their user base and targeting organizations separately, they could better allow organizations to engage users at the point of their own conversion and then charge a fee or take a piece of the lift resulting from the incremental awareness, engagement, and purchases or transactions generated by the system. This creates a significant new revenue opportunity for social network providers and is possible utilizing the herein described system.

### SUMMARY

In an embodiment of the present disclosure, the system may be deployed by organizations to engage their customers or users and motivate their customers or users to endorse a purchase or other transaction and to share the purchase or other transaction information (no matter where that purchase or transaction occurs—online, offline or mobile) at or near to the time of purchase or transaction or immediately following purchase or transaction via their social media contacts. A user can share with their connections on social media channels in order to leverage the user's influence within those social networks to drive additional brand awareness, brand engagement, and purchases or transactions. Such purchases or transactions as used herein may be referred to as conversions. A conversion represents any action that is desired by an organization and can include but is not limited to such user actions as a purchase, registration, application completion, lead completion, download, donation, view, click, redirect, renewal, comment, message, email, “Like”, “Follow”, or “Share”.

In an embodiment, a method, implemented on a machine having at least one processor, a storage device, and a communication platform connected to a network, for influencing a user's social networking contacts' decisions by utilizing social media is disclosed. The method comprising detecting, via the at least one processor, a transaction of the user, interfacing, via the communications platform, with the user's social networking contacts, sharing the user's transaction with the user's social networking contacts, and gathering information related to the sharing.

In a further embodiment, the transaction is at least one of the following: a donation, an in-person conversion, and an on-line conversion. In another embodiment, the interfacing occurs at the time of the transaction. In another embodiment, the interface is accomplished via at least a point of sale device, a computer, a smartphone, a tablet, a portable communications device, a proprietary device, and a card reader device. In an alternative embodiment, method further comprises issuing a record to the user of the transaction at the time of the transaction that allows the user to share the user's transaction via the communications platform at a time after the transaction.

In an embodiment, a method, implemented on a machine having at least one processor, a storage device, and a communication platform connected to a network, for engaging a user to share a conversion with a provider, with the user's social networking contacts via a social media network is disclosed. The method comprising detecting, via the at least one processor, the completion of the conversion of the user, launching, via the processor, an application on a user device, interfacing, via the communications platform, with the user's social networking contacts, sharing information about the user's conversion with the user's social networking contacts, and gathering information related to the sharing.

In another embodiment, the application stores information about the conversion, prompts the user for second information, and communicates third information to the processor. In still another embodiment, the information is a cookie. In another embodiment, the stored information has a built in preset expiration date.

In another embodiment, the second information relates to a goal set by the user and the user's social network. In another embodiment, the third information is conveyed via the network to a third party and wherein the third information is at least one of the following, a provider identifier, a conversion amount, and a conversion identifier.

In another embodiment, the goal set by the user is the shared information. In still another embodiment, the method further comprises providing a unique conversion identifier to a social network contact, monitoring if the social network contact selects the unique conversion identifier, directing the social network contact to the provider, and prompting the social network contact to complete a conversion.

In another embodiment, the unique conversion identifier directs the social network contact to a third party location and information related to the user's conversion is written to a device of the social network contact.

In still another embodiment, the method further comprising determining if the social network contact completes a second conversion. In another embodiment, social network contact information is conveyed to a third party via the communications platform, and the social network contact information relates to the second conversion.

In another embodiment, the secondary conversion is associated with the user.

In an embodiment, a system, for influencing a user's social networking contacts' decisions by utilizing social media is disclosed. The system comprising detecting, via a processor, a transaction of the user, interfacing, via a communications platform, with the user's social networking contacts, sharing the user's transaction with the user's social networking contacts, and gathering information related to the sharing.

In another embodiment, of the system the transaction is at least one of the following: a donation, an in-person conversion, and an on-line conversion. In another embodiment of the system the interfacing occurs at the time of the transaction. In still another embodiment of the system the interface is accomplished via at least one of the following: a point of sale device, a computer, a smartphone, a tablet, a portable communications device, a proprietary device, and a card reader device.

In another embodiment, the system comprises issuing a record to the user of the transaction at the time of the transaction that allows the user to share the user's transaction via the communications platform at a time after the transaction.

In an embodiment, a system, for engaging a user to share a conversion with a provider, with the user's social networking contacts via a social media network is disclosed. The System comprising, detecting, via a processor, the completion of the conversion of the user, launching, via the processor, an application on a user device, interfacing, via a communications platform, with the user's social networking contacts, sharing information about the user's conversion with the user's social networking contacts, and gathering information related to the sharing.

In another embodiment of the system the application stores information about the conversion, prompts the user for second information, and communicates third information to the processor. In still another embodiment of the system the information is a cookie. In still another embodiment of the system the stored information has a built in preset expiration date. In still another embodiment of the system the second information relates to a goal set by the user and the user's social network.

In another embodiment of the system the third information is conveyed via the communications platform to a third party wherein the third information is at least one of the following: a provider identifier, a conversion amount, and a conversion identifier. In still another embodiment of the system the goal set by the user is the shared information.

In another embodiment the system further comprises providing a unique conversion identifier to a social network contact, monitoring if the social network contact selects the unique conversion identifier, directing the social network contact to the provider, prompting the social network contact to complete a conversion. In still another embodiment of the system the unique conversion identifier directs the social network contact to a third party location and information related to the user's conversion is written to a device of the social network contact. In another embodiment the system further comprises determining if the social network contact completes a second conversion. In still another embodiment of the system after the second conversion occurs, a social network contact information is conveyed to a third party via the communications platform, and the social network contact information relates to the second conversion.

In still another embodiment of the system the secondary conversion is associated with the user. In still another embodiment of the system the interfacing occurs at the time after the transaction.

In an embodiment a method implemented on a machine having at least one processor, a storage device, and a communication platform connected to a network, for tracking a user's influence over subsequent users is disclosed. The method comprising: detecting, via the at least one processor, an action of the user, interfacing, via the communications platform, with subsequent user's from the user's social networks, distributing, via the communications platform, an application to the subsequent user's, in response to the user's action, tracking the effects of the user's action on the subsequent user's, and gathering information related to the tracking.

In another embodiment the gathering relates to the ripple effect of the user's action. In another embodiment the action is a selection of content. In another embodiment the action is a conversion. In another embodiment the application is an identifier unique to the user. In another embodiment the information is presented in a report. In still another embodiment the report displays the user's influence and impact on the subsequent users.

In another embodiment the method further comprising, establishing a campaign with a target goal for the user, providing an incentive to the user to take the action in furtherance of the target goal, rewarding the user for reaching the target goal. In another embodiment the incentive is based on a user's demographics. In still another embodiment the user's action is the selection of content provided by an organization and the organization is able to view a plurality of campaigns in the aggregate or individually.

In an embodiment a system for tracking a user's influence over subsequent users is disclosed. The system comprising, detecting, via a processor, an action of the user, interfacing, via a communications platform, with subsequent user's from the user's social networks, distributing, via the communications platform, an application to the subsequent user's, in response to the user's action, tracking the effects of the user's action on the subsequent user's, gathering information related to the tracking.

In another embodiment of the system, the gathering relates to the ripple effect of the user's action. In another embodiment of the system, the action is a selection of content. In still another embodiment of the system, the action is a conversion. In still another embodiment of the system, the application is an identifier unique to the user.

In another embodiment of the system, the information is presented in a report. In still another embodiment of the system, the report displays the user's influence and impact on the subsequent user's.

In another embodiment the system further comprising establishing a campaign with a target goal for the user, providing an incentive to the user to take the action in furtherance of the target goal, rewarding the user for reaching the target goal. In another embodiment of the system, the incentive is based on a user's demographics. In another embodiment of the system, the user's action is the selection of content provided by an organization wherein the organization is able to view a plurality of campaigns in the aggregate or individually.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts the main stages of the sharing system in accordance with an embodiment of the present disclosure;

FIG. 2 depicts a high level user and data flow in accordance with an embodiment of the present disclosure;

FIG. 3 depicts various ways to launch or trigger the launching of the software of present system in accordance with an embodiment of the present disclosure;

FIG. 4 depicts an embodiment of a motivation screen in accordance with an embodiment of the present disclosure;

FIGS. 5a-c depicts various embodiments of motivation screens in accordance with an embodiment of the present disclosure;

FIG. 6 depicts a motivation box showing how many times user's Shared their conversions in accordance with an embodiment of the present disclosure;

FIG. 7 depicts an alternative motivation box in accordance with an embodiment of the present disclosure;

FIG. 8 depicts a smart box for motivating a customer in accordance with an embodiment of the present disclosure;

FIGS. 9a-b depict thank you boxes intended to motivate in accordance with an embodiment of the present disclosure;

FIGS. 10a-b depict a multilayer smart box in accordance with an embodiment of the present disclosure;

FIG. 11 depicts a summary report in accordance with an embodiment of the present disclosure;

FIG. 12 depicts a typical user interaction in accordance with an embodiment of the present disclosure;

FIG. 13 depicts a typical customization page for a user interaction in accordance with an embodiment of the present disclosure;

FIG. 14 depicts an alternative interaction customization page in accordance with an embodiment of the present disclosure;

FIG. 15a-b depict alternative interaction customization pages in accordance with an embodiment of the present disclosure;

FIG. 16 depicts a typical post by a user of the system on a social networking site in accordance with an embodiment of the present disclosure;

FIGS. 16-19 depict typical posts by a user of the system on a various social networking sites in accordance with an embodiment of the present disclosure;

FIG. 20 depicts an example of a Conversion Page in accordance with an embodiment of the present disclosure;

FIG. 21 depicts an example of a transactional report in accordance with an embodiment of the present disclosure;

FIG. 22 depicts an example of a donation report in accordance with an embodiment of the present disclosure;

FIG. 23 depicts an example of a ripple effect report in accordance with an embodiment of the present disclosure;

FIG. 24a depicts another example of a ripple effect report in accordance with an embodiment of the present disclosure;

FIG. 24b depicts another example of a ripple report in accordance with an embodiment of the present disclosure;

FIG. 25 depicts an example of a visit (also known as referrals) and revenue report in accordance with an embodiment of the present disclosure;

FIG. 26 depicts an example of a lift report in accordance with an embodiment of the present disclosure;

FIG. 27 depicts an example of a program summary report in accordance with an embodiment of the present disclosure;

FIG. 28 depicts a flow chart of the steps used by a user to set a goal in accordance with an embodiment of the present disclosure;

FIG. 29 depicts a flow chart of the steps used by a user's connection to set a goal in accordance with an embodiment of the present disclosure;

FIG. 30 depicts another example of a motivation screen used in accordance with an embodiment of the present disclosure;

FIG. 31 depicts an exemplary goal setting screen in accordance with an embodiment of the present disclosure;

FIG. 32 depicts an exemplary social media log in screen in accordance with an embodiment of the present disclosure;

FIG. 33 depicts an exemplary posting permissions screen accordance with an embodiment of the present disclosure;

FIG. 34 depicts an example of a posting screen in accordance with an embodiment of the present disclosure;

FIG. 35 depicts an exemplary personal goal results report in accordance with an embodiment of the present disclosure;

FIG. 36 depicts an exemplary lead screen in accordance with an embodiment of the present disclosure;

FIG. 37 depicts an overview of the present system in accordance with an embodiment of the present disclosure;

FIG. 38 depicts a general computer architecture on which the present teaching can be implemented.

FIG. 39 depicts an exemplary dialog box of an embodiment of the system that may be automatically presented to a user if the system detects the user is browsing via a mobile device; and

FIG. 40 depicts another example of a dialog box in an embodiment of the system that can automatically be presented to a user if the system detects the user is browsing via a mobile device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

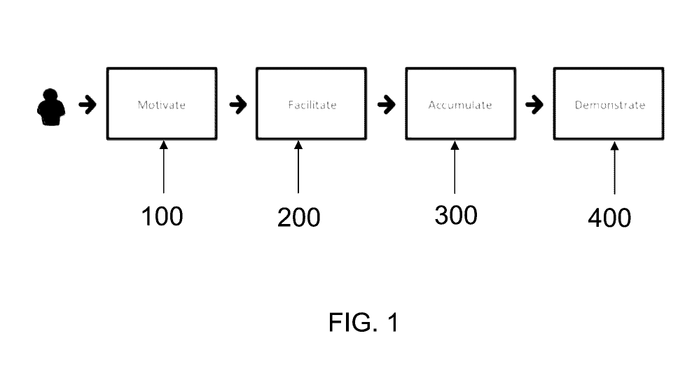

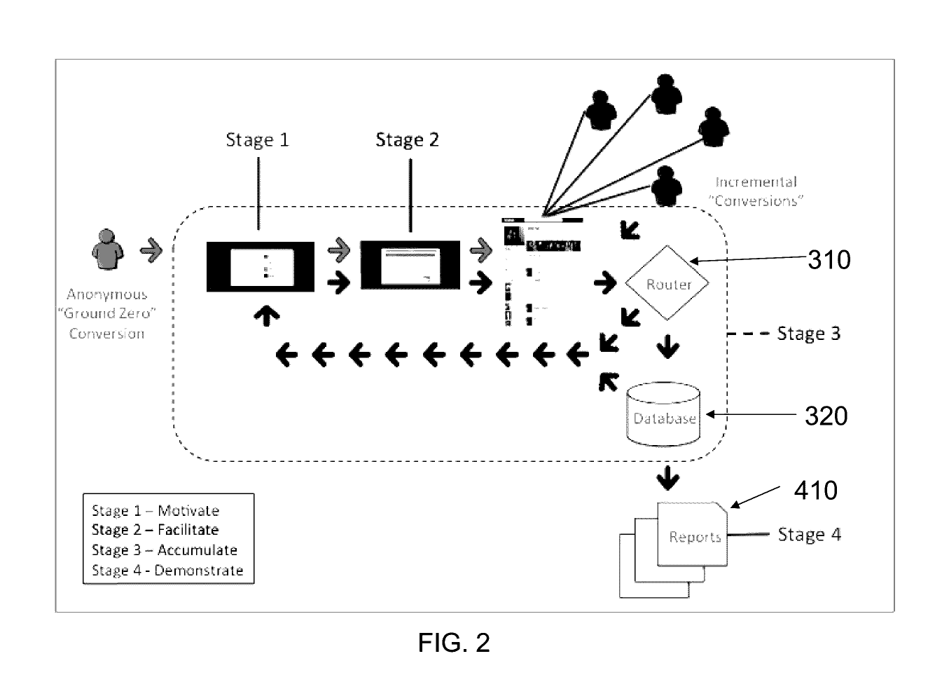

As depicted in FIG. 1, the system and method of the present disclosure is comprised of four unique sequential stages: the motivate stage 100, the facilitate stage 200, the accumulate stage 300, and the demonstrate stage 400. FIG. 2 depicts a high level depiction of the four stages of a user and data flow of an embodiment of the present disclosure. At stage 1, the motivate stage 100, the user completes a conversion and may then be prompted to share the experience of the conversion via a social media platform. At stage 2, the facilitate stage 200, the user completes the information to post their experience of the conversion to their social media pages. At step 3, the accumulate stage 300, the user's conversion experience is shared with their social network followers, who then become exposed to the organizations the user interacted with. These new user's may also choose to interact with that organization and that information may then be routed through router 310. Router 310 may send all the incremental conversion information to database 320 for data capture and storage. Once stored in database 320, the incremental user conversion information may be output as part of the demonstrate stage 400 in report 410 or graphical format.

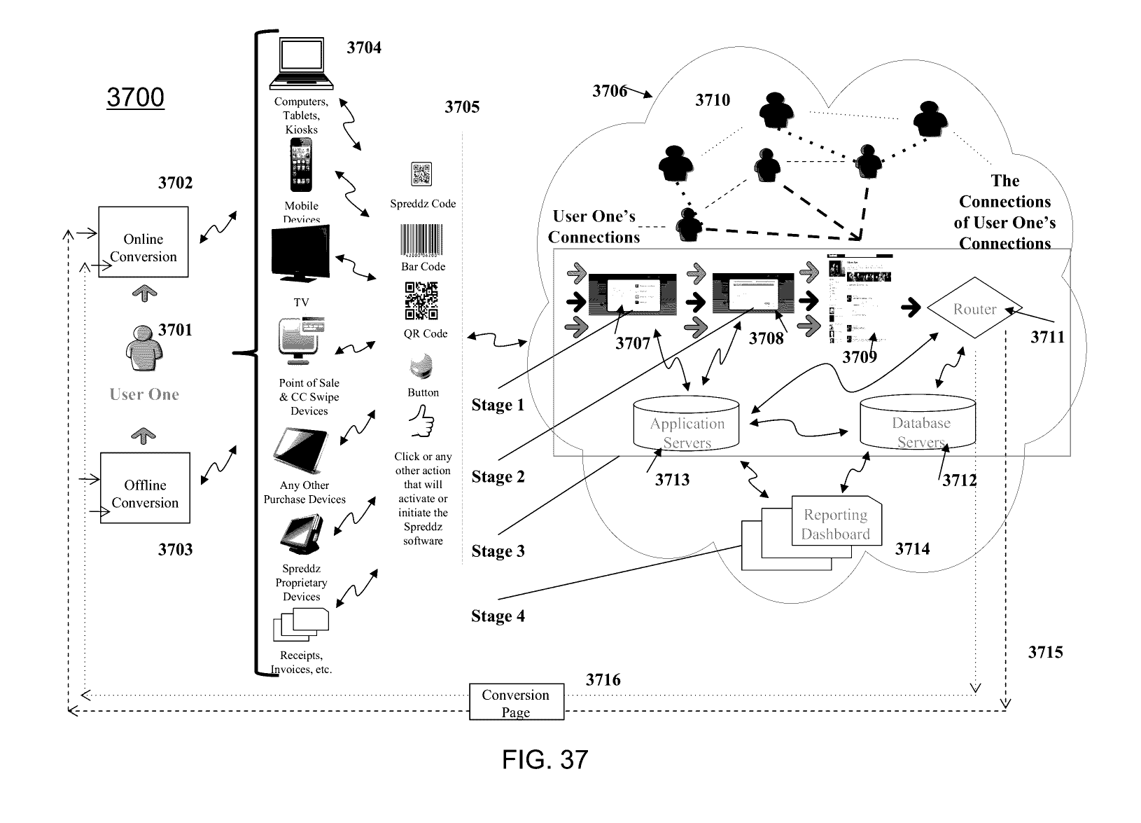

FIG. 37 depicts a high level system 3700 in accordance with an embodiment of the present disclosure. Customer 3701 may be an existing customer or a new customer. Customer 3701 interacts with the organization and engages in an online conversion 3702. Customer 3701 may also make an off line or live interaction or conversion 3703. During or after either conversion, customer 3701 is engaged by the system technology and/or software via device 3704. Device 3704 may be a computing device, such as a computer, laptop, tablet computer, it may be a mobile device, an interactive television, a point of sale or credit card device. Device 3704 may also be any other device located at the point of sale, it may be a proprietary device, or a multipurpose device, and it may even be provided in hard copy form, such as a paper sales receipt, with the information to allow the user 3701 to complete the interaction at a later point in time at the same or different location. Any one of the devices 3704, may allow the user to interact in a number of ways 3705. Device 3704 may provide an interface to allow the user 3701 to proceed to the motivation stage (Stage 1). These included but are not limited to, a proprietary system code, a bar code, a QR code, an interactive or selectable button provided on any one of the device 3704.

Additionally and/or alternatively, the interaction or engagement 3705 is initiated automatically through system code or through another action taken by the customer, such as scanning a bar code, entering an access code, etc. System 3700 may comprise a router, 3711, a database 3712, and application server 3713, all which may be connected on a network. System 3700 may be cloud based 3706 or hosted on one or many servers with various aspects of the system being carried out on one or more servers and carried out over a network.

In operation, system 3700 engages the customer and motivates (Stage 1) them to share their conversion with their social media connections. This may be accomplished by presenting to the user, motivation screen 3707. After viewing motivation screen 3707 and determining that he or she wishes to share their conversion the system 3700, facilitates (Stage 2) the sharing process for the customer by providing access to facilitate screen 3708, which allows user 3701 to format their share with their social media connections. User 3701 shares via various social media outlets and that information is posted to the chosen social media channels with a unique, dynamically generated link via web page 3709. At 3710, the user's post is seen by customer 3701's social media connections. This post may contain information to help an interested connection convert such as but not limited to an address, phone number, or coupon. An interested connection may go directly to the organization's location to convert or they may click on a unique link presented in post 3709 and be routed via router 3711 to learn more about the customer's conversion and how to convert themselves. If the connection is using a mobile device, they may also be engaged and asked whether they want to learn more or convert by calling a unique tracking phone number dynamically generated by the system. Database 3712 captures the connection's interactions and accumulates (Stage 3) conversion information on every interaction all under the control of application server 3713. Reports of all the conversions and interactions, can be displayed via reporting dashboard 3714. Reporting dashboard 3714 displays the captured data in a form that is relevant to organizations in order to demonstrate (Stage 4) the effectiveness and results of the system 3700's performance. When connections are routed via 3711 back to learn more about the user's conversion and how to convert themselves, they may first go to a Conversion Page 3716 which is intended to facilitate getting the connection to the appropriate location and help to drive a range of conversions.

### Stage 1—Motivate

In an embodiment, the “Motivate” stage 100 is designed to engage with the customer immediately during or after a “conversion” and inspire or motivate that customer or user to share the fact that they just made a conversion with their social media connections.

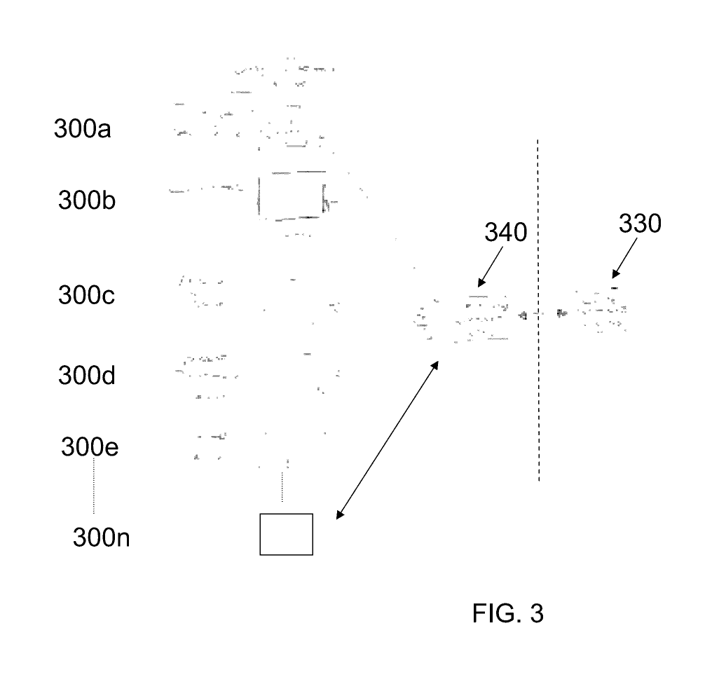

As seen in FIG. 3 and FIG. 37, conversion's can occur on any interface (300a-300n) a customer sees upon completing the desired user action (either online or offline) including but not limited to:
Point of Sale Devices (300a)
Computers (300b)
Mobile Phones (300c)
Proprietary Devices (300d)
Other Mobile devices (300e-300n)
Tablets
Cash Registers
Kiosks
Product Terminals
Credit Card Swipe Devices
Televisions
Interactive/Web-enabled TVs or similar home viewing devices
TV shows
Interactive TV shows
Webisodes
Podcasts
Websites
Microsites
Web pages
Web applications
Mobile applications
Mobile wallet devices
Videos
Streaming media
Paper receipts
Paper invoices

Interfaces may also happen at or near the time of conversion or at some later point in time.

### The User Experience in the Motivate Stage

At the point of conversion, the technology platform of the present disclosure may engage the customer and motivate or inspire them to share the fact that they just made the conversion. In an embodiment, the computer code or software used to engage with the customer after a conversion is stored remotely in servers 330 and accessed through a Software As A Service (SAAS) model. Alternatively and/or additionally, the software may be stored in several servers across several platforms. It may be cloud based and stored on leased or rented resources or may be stored or resident on proprietary devices. In an interactive environment, the application can be deployed automatically at the point of conversion or can be requested by the seller or organization for select customers based on specific criteria.

In an embodiment, a part of the software (client-side code) 340 may reside at the point of conversion, and may interact with the provider's servers as required. The application may self launch, triggering the full platform.

In an embodiment, when it is not possible to embed software or code at a customer location, i.e., a non-interactive environment, the system and method may still inspire the customer (e.g., motivational text or monetary or other reward) to take an action that will then deploy the system or method. (e.g., scan a barcode or QR code, send a text message, make a mobile call, scan an RFID device, launch a mobile app) at a later time. The inspirational method may be anything that will cause the customer to follow up on completing the transaction with the present system and method.

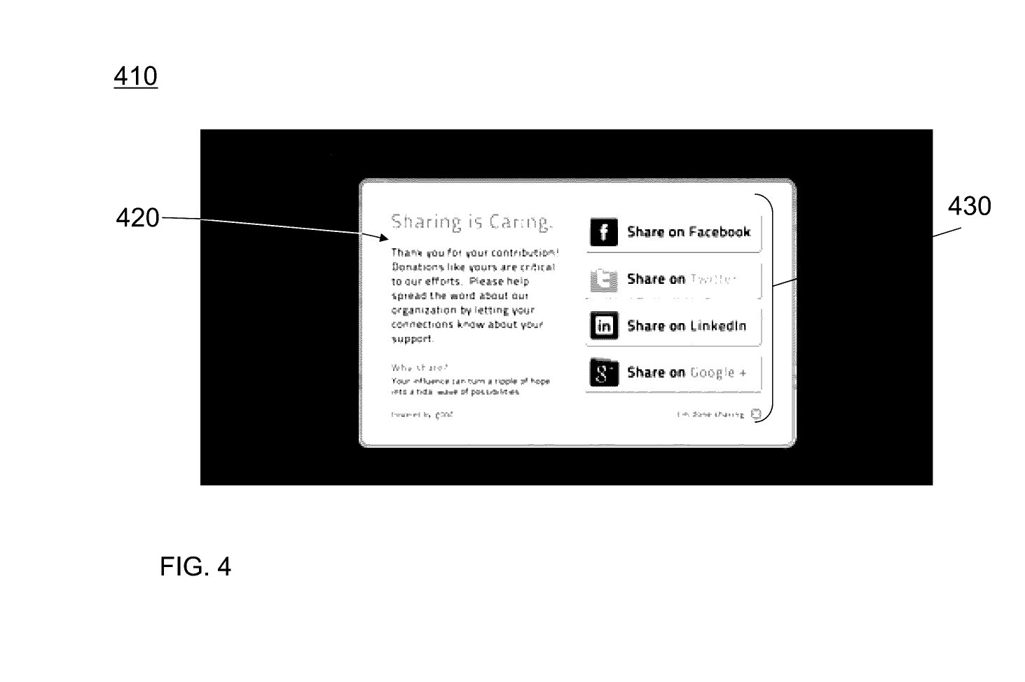

In an embodiment, the user interacts directly with the software that is integrated into the existing conversion experience as part of the motivate stage 100. FIG. 4 is an example of a customer being engaged during motivate stage 100 in an embodiment of the present invention. As seen in FIG. 4, the user may have just made a purchase or donation on a Website. Following the purchase, the customer is engaged by the motivation stage software and inspired by motivation box 410 to share their purchase or contribution with their social media connections. In this example, the customer engagement begins with JavaScript code 340 (however, this approach is not limited to JavaScript code as a wide variety of software technologies, such as Flash, HTML5, Video, or any other software or programming technique, can be used to provide this client-side functionality) being deployed by the organization on the organization's confirmation page (shown in the background of motivation box 410). When the customer reaches the confirmation page of the web site it is interacting with, JavaScript code 340 begins the interaction with the core platform and launches the motivation box 410. As seen in FIG. 4, a message 420 is used to motivate the user to move to the next stage of the process. In addition to message 420 or any other information, the user may be presented with buttons 430 to select a social media site on which to share their conversion. The number and type of social media channel can be added and removed from the system as the social media landscape evolves. The user may elect to share with their connections without any additional prompting or specific messaging, content, data, measurements, incentives, or other tools or techniques may be used to increase a user's desire to share.

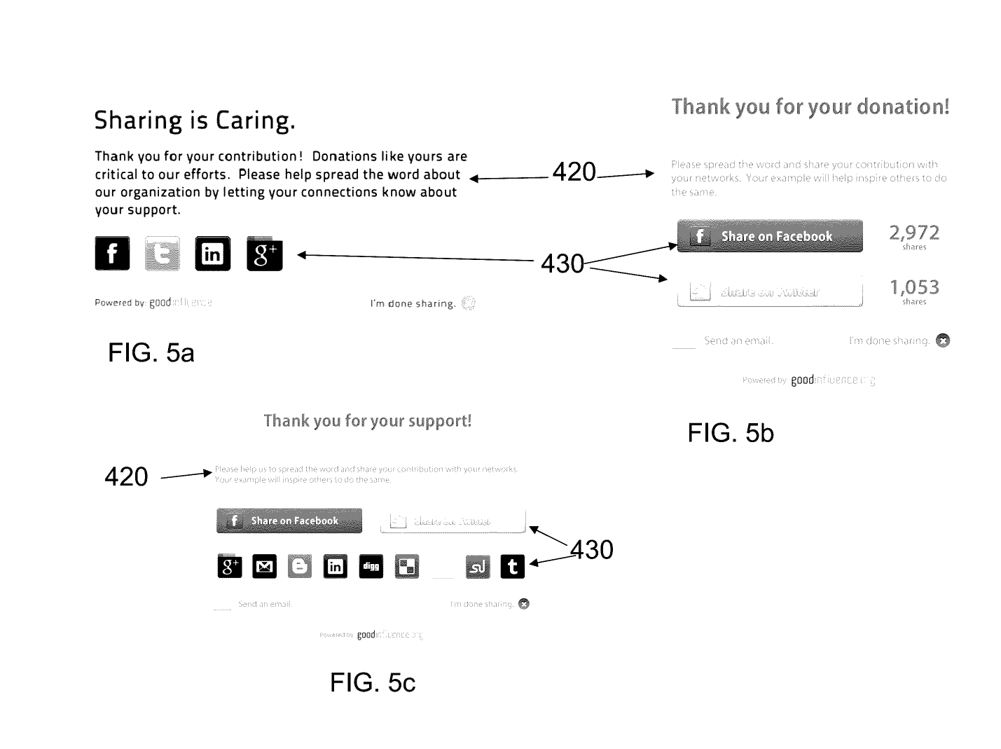

FIGS. 5a-5c show various embodiments of motivation box 410 all of which disclose a message 420 and buttons 430. FIG. 5b disclose a motivation box 410 with just the top two social channels for selection, while FIG. 5c highlights two top channels but including others as well.

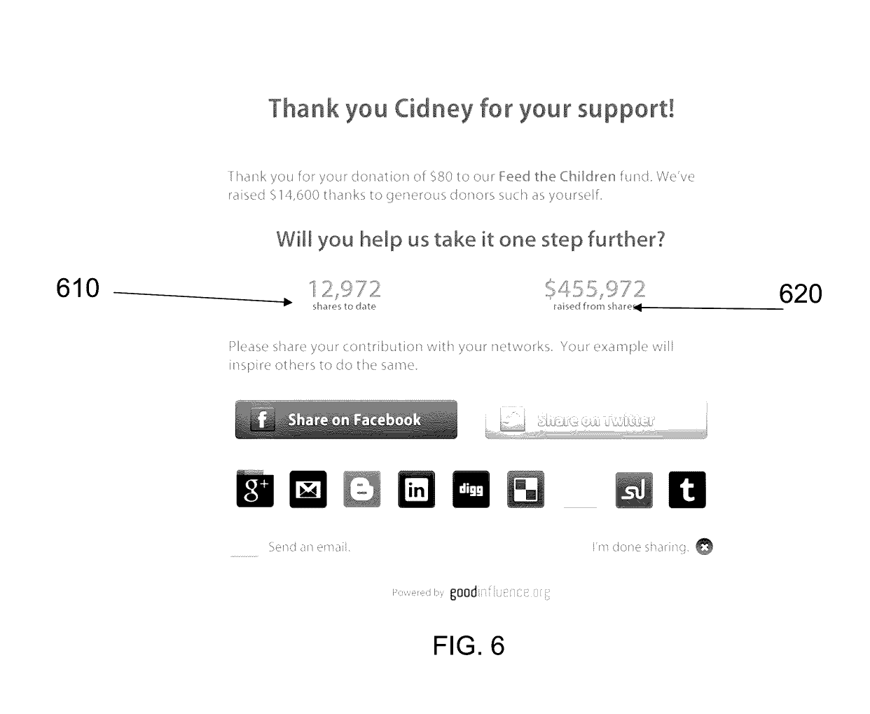

FIG. 6 discloses another embodiment of a motivation box showing how many times user's Shared their conversion, “Shares to Date” 610, and the amount “Raised from Shares” 620. In an embodiment of the present disclosure, these numbers/totals are updated in real-time for the user or may be periodically updated. In an embodiment, the motivational box may be personalized to contain personalized information by using parameters, such as the user's name, the product type, the quantity, the purchase price, the quantity remaining, a coupon, a discount code, a reward, a unique message, the name of the organization or business. Personalization may occur via the parameters within the client-side code that are passed into the platform.

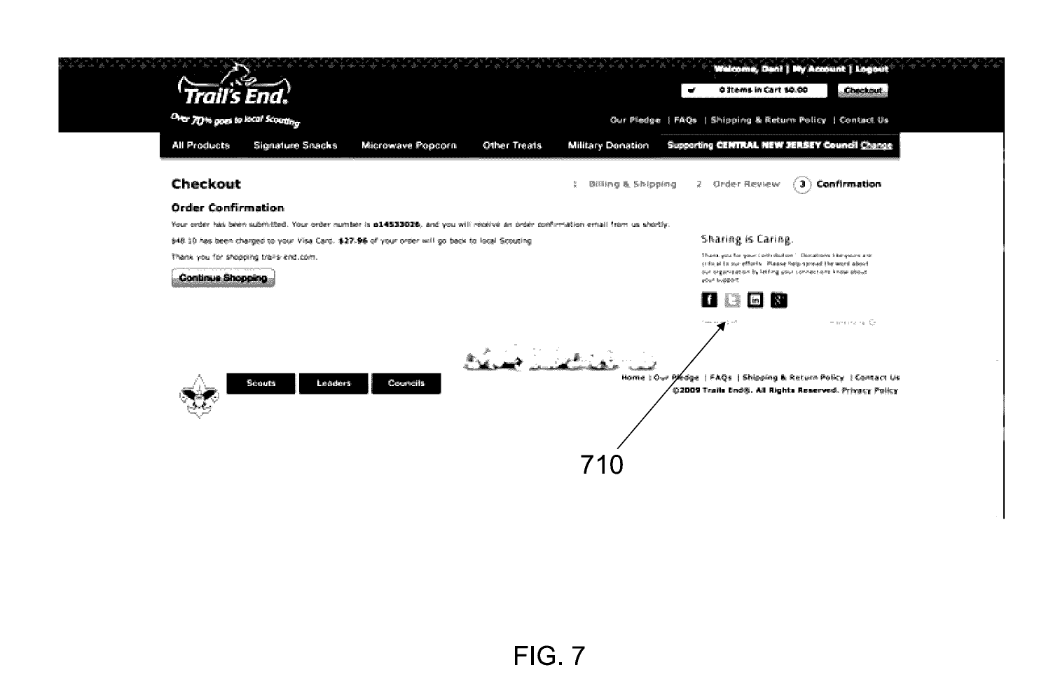

FIG. 7 discloses an embodiment that utilizes another type of motivation box 710 to engage a user during the Motivate Stage. In this embodiment, the motivational box is displayed in a small gray banner on the right-hand side of the page rather than on top or overlaid on the underlying confirmation page. It is to be understood, that the motivational box may be presented in several ways without departing from the spirit of the invention.

For example, the customer engagements in FIGS. 4-7 may begin with the use of an inline frame or iFrame, a customer engagement based on the present disclosure can occur through a wide range of software technologies including but not limited to iFrames, pop-ups, lightboxes, overlays, links, video, or Flash depending on the type of application (i.e., mobile, tablet, desktop, laptop).

In an embodiment, the look and feel of the motivation box is completely customizable by the organization. Customization includes, but is not limited to size, placement, colors, and content. Additionally, and/or alternatively, all elements within the experience can be changed automatically by an administrator within the organization through a password-protected or other secure interface into the platform.

In an embodiment of the present disclosure, a key advantage and differentiator of the present platform is the fact that it may provide options regarding the type of technology (e.g., iFrames, pop-ups, lightboxes, overlays, links, video, Flash) used in the Motivate stage. Many existing social networks (e.g., Facebook™) often use pop-ups. However, there is a disadvantage to this approach. Most consumers and users have pop-up blockers within their browsers that either eliminate pop-ups or greatly reduce their effectiveness. As a result, the pop-ups cannot automatically engage most users without being blocked. So, if the customer does not first engage the social networking site via its icon, that is typically positioned as a small badge on the page, the social network can not launch its pop-up. The fact that the customer must take an action to engage the technology creates a significant hurdle that will drive a lower overall engagement rate. The present disclosure is able to avoid this problem by using other options to display the motivation box, such as the use of iFrames.

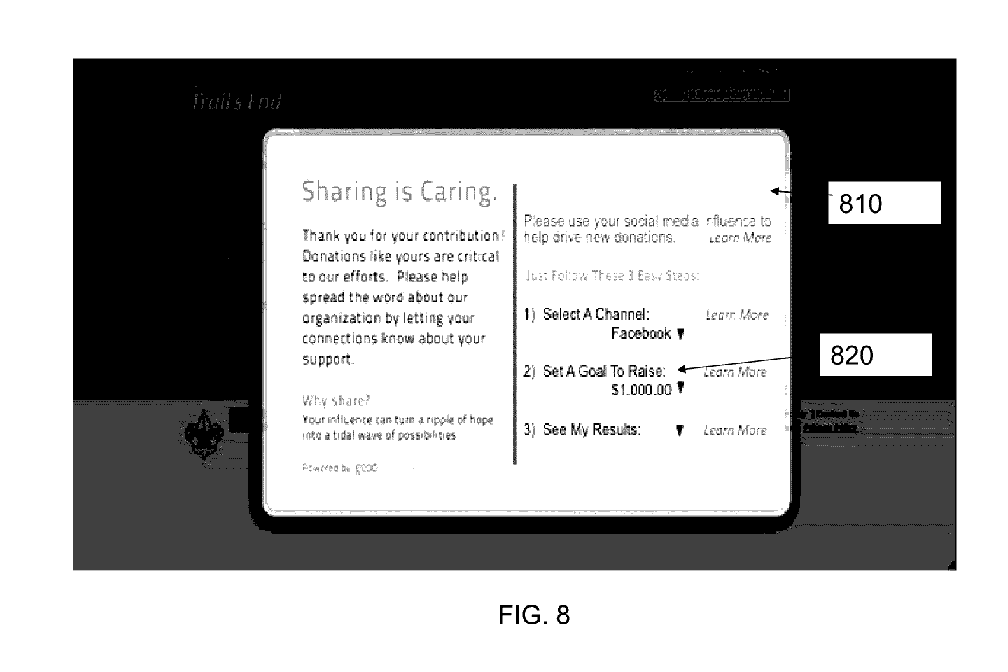

In an embodiment, a Smart Box may be used to capture additional information about the user. FIG. 8 depicts a single layer smart box 810. The objective of smart box interface is to allow the platform to capture more information from the user or customer to allow the latter stages of the process to have more impact. The Smart box interface asks the customer to complete a series of targeted questions, captures the responses within a database and utilizes those answers to personalize the content and experience in the remaining stages. FIG. 8 is an example of a single layer smart box, i.e., where all the information is gathered in a single frame. This interaction during the motivational stage supplies the system with more data to use for the latter stages. As seen, in FIG. 8, the single layer smart box 810 allows the user to input all the requested information in one box. However, the interactions may be spread over several screens and are not limited to any one set of data.

In an embodiment, a very important field of information that will be captured within the Smart Box is “Goal”. The goal amount 820 is the amount the customer hopes to raise, sell or achieve through his or her social media connections. This sort of goal setting is important because it motivates additional connections who are then more likely to purchase or donate in order to help a friend or colleague reach a predefined organization or personal goal. This feature of the present disclosure is called Goal Setting.

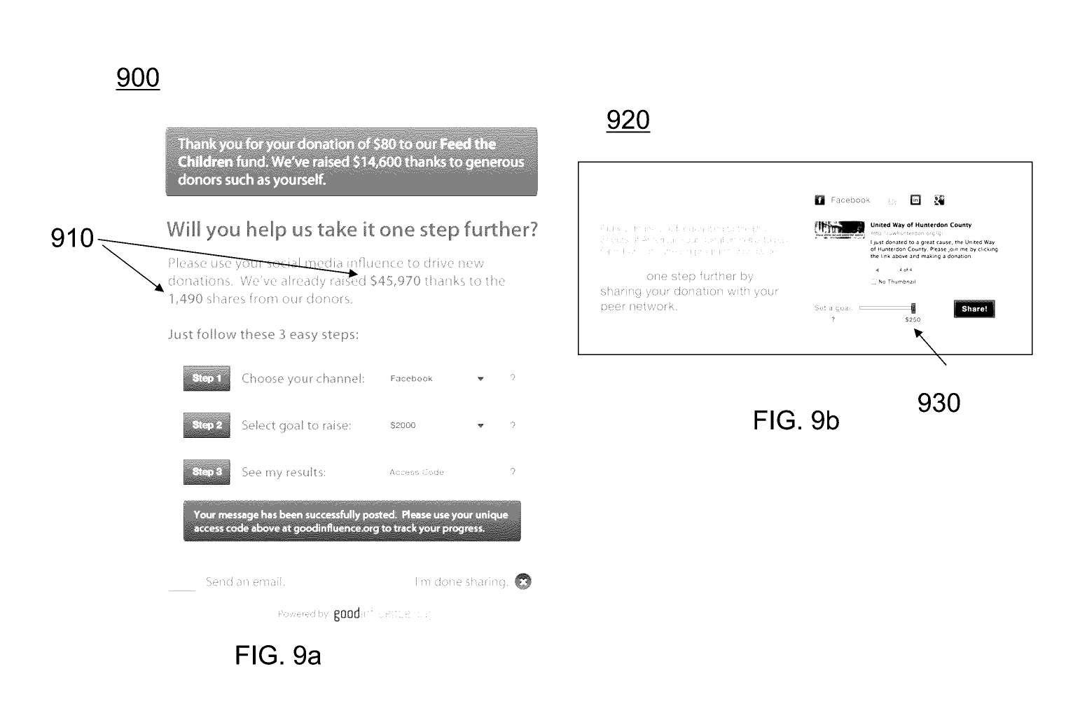

FIGS. 9a and 9b depict additional single layer smartboxes. As seen in FIG. 9a, single layer smart box 900 contains personalized content 910 passed by the organization into the platform using the parameters provided within the technology. As with Smart Box 810, smart box 900 collects all the information at once. Smart Box 920 seen in FIG. 9b while, still single layer smart box, only collect a single piece of information, in this example, goal 930. It is to be understood that as much or as little information as the organization wishes to seek can be presented in a single or multi-layer smart box.

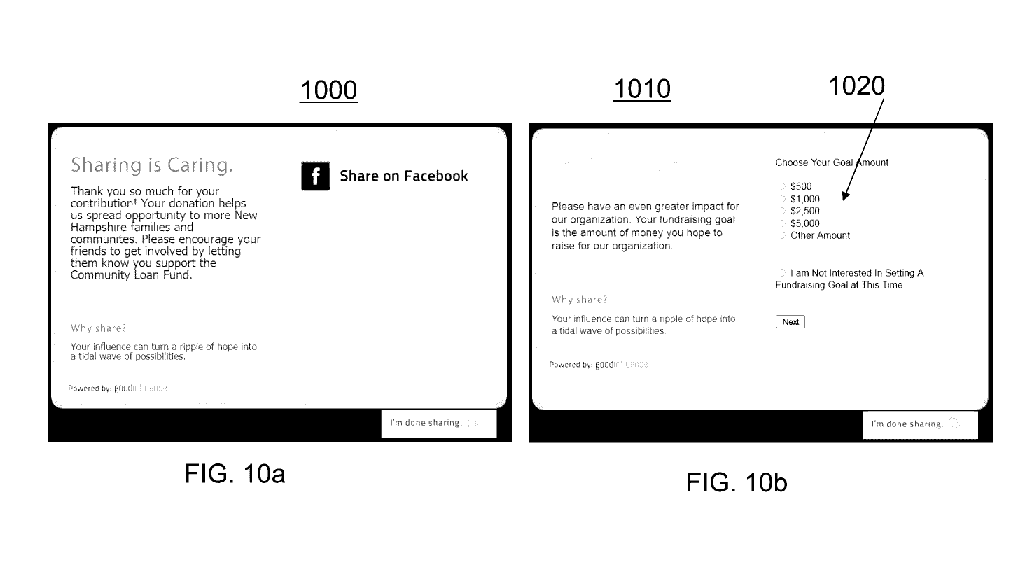

FIGS. 10a-b depict an embodiment of a multi-layer smart box in accordance with the present disclosure. The multi-layer smart box may collect the same or different information as the single layer smart box, but does so across multiple boxes, screens, frames, or windows. FIG. 10a discloses a first smart box 1000 a user might encounter during the motivation stage 100 and FIG. 10b discloses a second smart box 1010, the user encounters as part of the same transaction. It is to be understood, that the number of multilayer smart boxes used is not limited to two, but to how much information needs to be collected. Single or multiple pieces of information may be collected on each screen through each box. For example, smart box 1000 may be the opening screen and smart box 1010 may be the next or last screen. As seen, in FIG. 10b, smart box 1010 collects a single piece of information 1020, but other information might also be collected in this smart box 1010 as well.

### A/B and Multivariate Testing—Motivation Stage

A feature of the present disclosure allows the organization to determine which is the most effective way to entice donors/customer into sharing his or her social networking contacts and accordingly, to increase exposure and drive increased sales and or contributions. In an embodiment of the present disclosure, various forms of testing (e.g., A/B, multivariate) may be employed to test a variety of creative concepts, content, placement, and rewards to determine which maximizes user engagement. The system of the present disclosure is designed to dynamically alternate various versions of the motivational box 410 in real-time to measure which version drives the greatest results so that an organization can use the version most likely to generate additional conversions.

### Use of Parameters—Motivation Stage

The present disclosure enables a user organization to pass organization-defined parameters into the platform in stages. In Stage 1, those parameters can be used to customize the content within the motivational box. As an example, if the customer just purchased a product or made a donation for $100, the experience in FIG. 6 can be customized to say something like “Thank you for your $100 donation.” The objective of customizing the user engagement is to drive greater customer interaction.

### Measuring the Motivation Stage

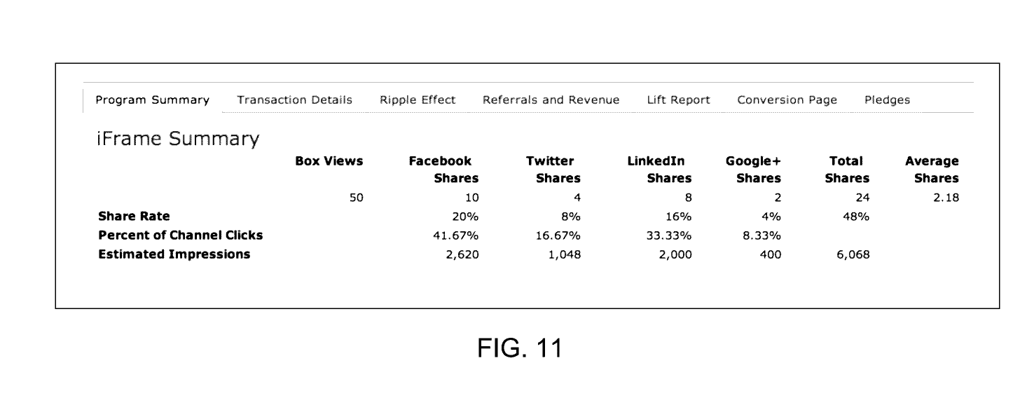

In order to be able to measure the specific interaction with the software in Stage 1, the motivation stage 100, the present disclosure can be configured to generate a Stage 1 results report. FIG. 11 is an example of a “Stage 1 Summary Report” to help the organization understand a customer's interaction with the motivation box in accordance with an embodiment of the present disclosure. This data will also help the organization optimize this stage for greater conversion.

### Facilitate Stage

The second stage of the system if the “Facilitate” stage 200. In this stage, once the customer chooses to interact with the motivation box, the system is designed to guide them through the process of sharing information with their social media connections.

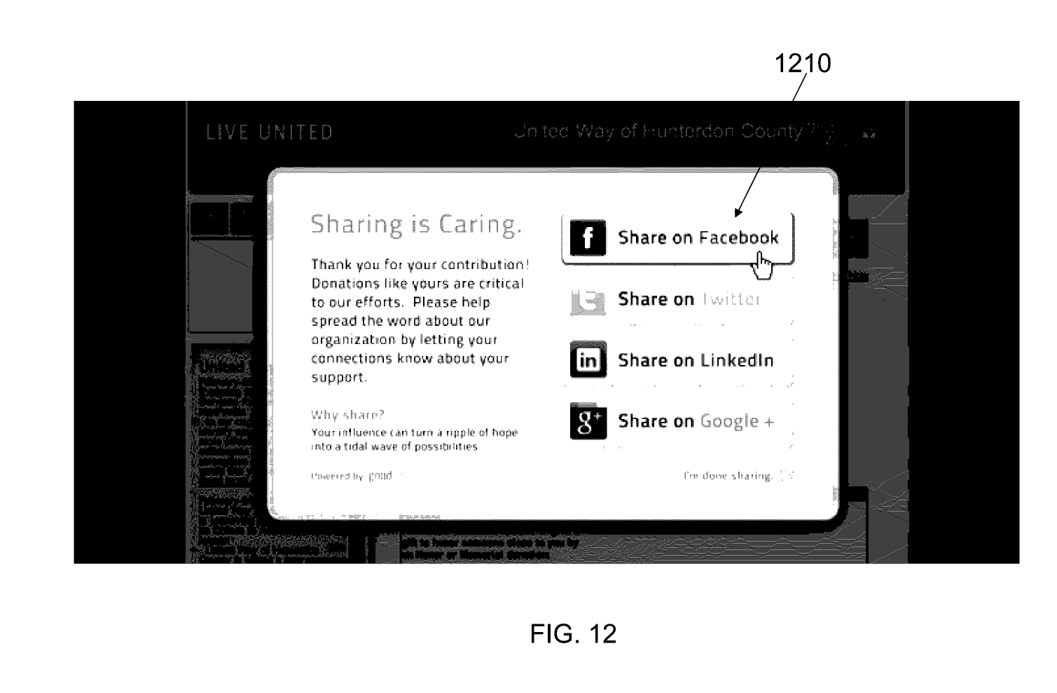

FIG. 12 depicts is an example of a customer choosing to interact with the motivation box 410 by choosing to share on Facebook by selecting the Facebook button 1210. This moves the customer from Stage 1 (the Motivate Stage 100) of the platform to Stage 2 (the Facilitate Stage 200).

Once the customer selects a social media channel by clicking on Facebook button 1210, the interaction with that channel begins. If the customer is not already logged into the chosen channel, they will be prompted to do so. If they are already logged in, they will begin to develop the content that they will post to their “wall” on the chosen social media channel. Although other avenues of sharing data with a social network can be used without departing from the spirit of the disclosure. It is important to note that all of the major social media channels provide such an interface. This configuration essentially allows a way to log into the social media channel via another website, post something to the user's wall or other information sharing platform on the social media channel, and then return to the original website. The present disclosure leverages and takes advantage of these interfaces.

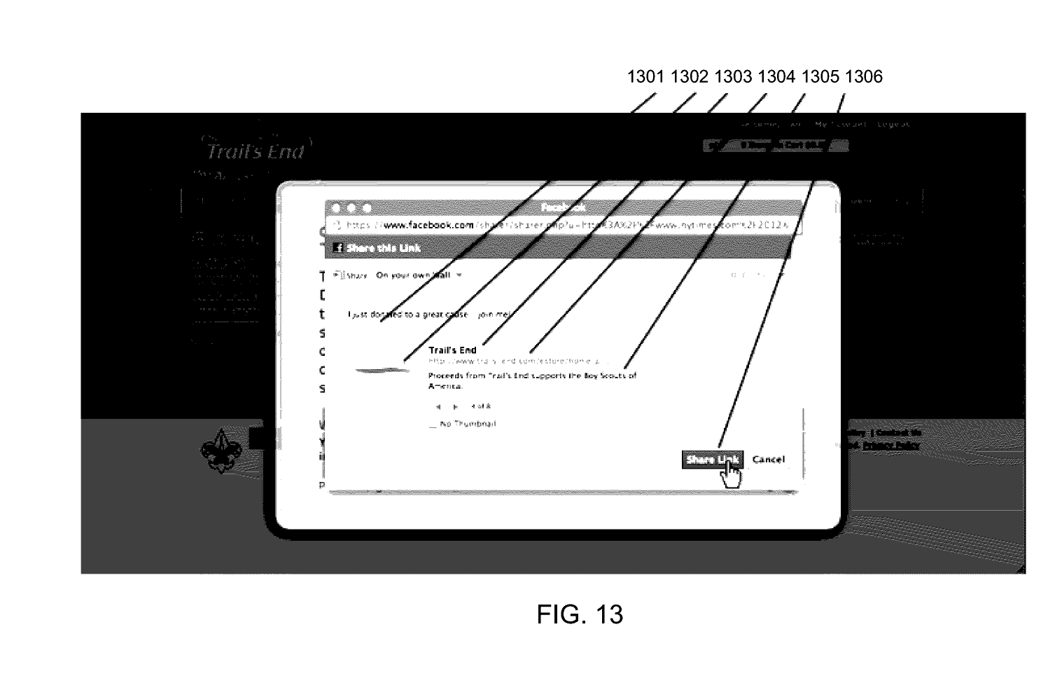

FIG. 13 depicts a user experience in the Facilitate Stage 200 in accordance with the present disclosure. Such an interface (or a similar interface) is provided by most major social media channels. Slight variations, with the addition of more or less interactive fields is possible. While the parameters (e.g., character limitations) of each interface are different depending on the social media platform, the present system works within these rules to maximize the potential impact of the user's post. In FIG. 13, the initial content in box 1301 is provided to the user in order to allow them to customize the introduction of the post or comment. Symbol, image, or logo 1302 is chosen by the organization using the system and is preloaded and stored within the system platform and then dynamically populated in real-time into the post. Symbol, image, or logo 1302 is not customizable by the user. However, it is completely customizable by the organization through a protected interface into the system platform. Title 1303, may be the name of the organization or any other name, title, promotional name, abbreviation, etc. and is also selected by the organization and completely customizable by the organization through the interface to the system platform. The title 1303 is stored within the system platform and dynamically inserted in real-time. The title 1303 is not customizable by the user. Link 1304 is a hyper link or any other address for routing a user to a specific location and is dynamically generated by the system technology platform and pre-populated into the post in real-time. Link 1304 is not customizable by the user or the organization. Link 1304 is critical to the routing and reporting functionality in Stages 3 (Accumulate 300) and 4 (Demonstrate 400) of the System technology platform. It is a link generated by the system platform that uniquely identifies the organization and the user. This link may be shown as a link or it may be shown as text with a hyperlink to this link. Content 1305 is selected and customizable by the organization. It is pre-populated by the organization into the system platform through the protected interface and dynamically served into the post in real-time. It is not customizable by the user. Button 1306 is a share button. Once the user is satisfied with the post, they hit button 1306, which may be provided by the social network, and the user's wall is then updated with the post for all of their social media connections to see.

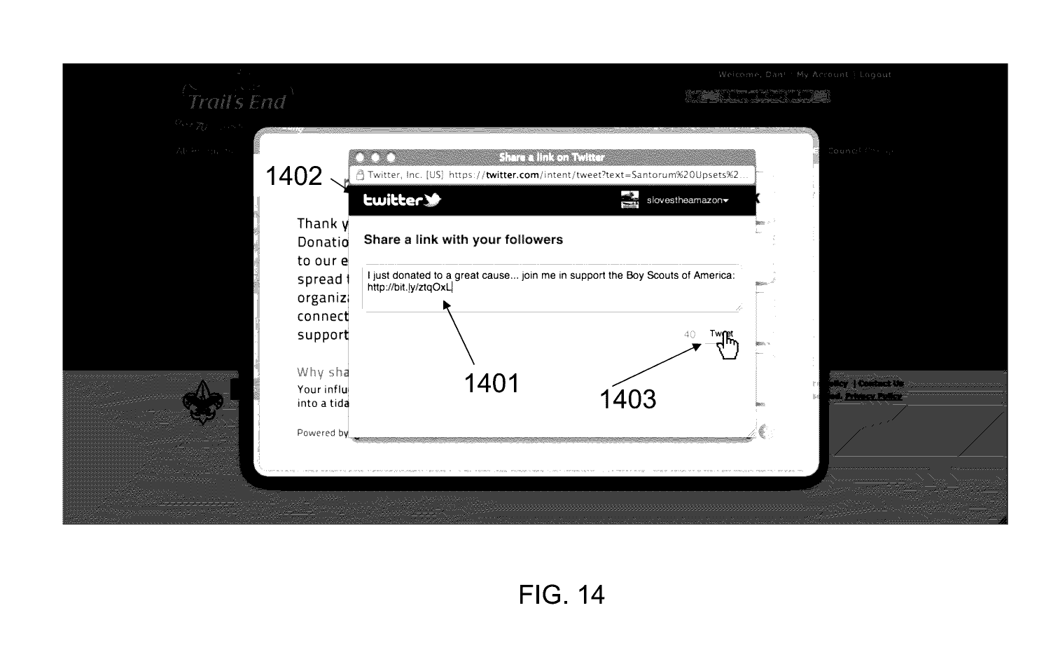

FIG. 14 is another example of a facilitate box typically found on social media site Twitter. Similar to FIG. 13, the user can populate a message in content box 1401, the social media's logo is found at 1402 and the share button 1403 is used to finalize the post once complete.

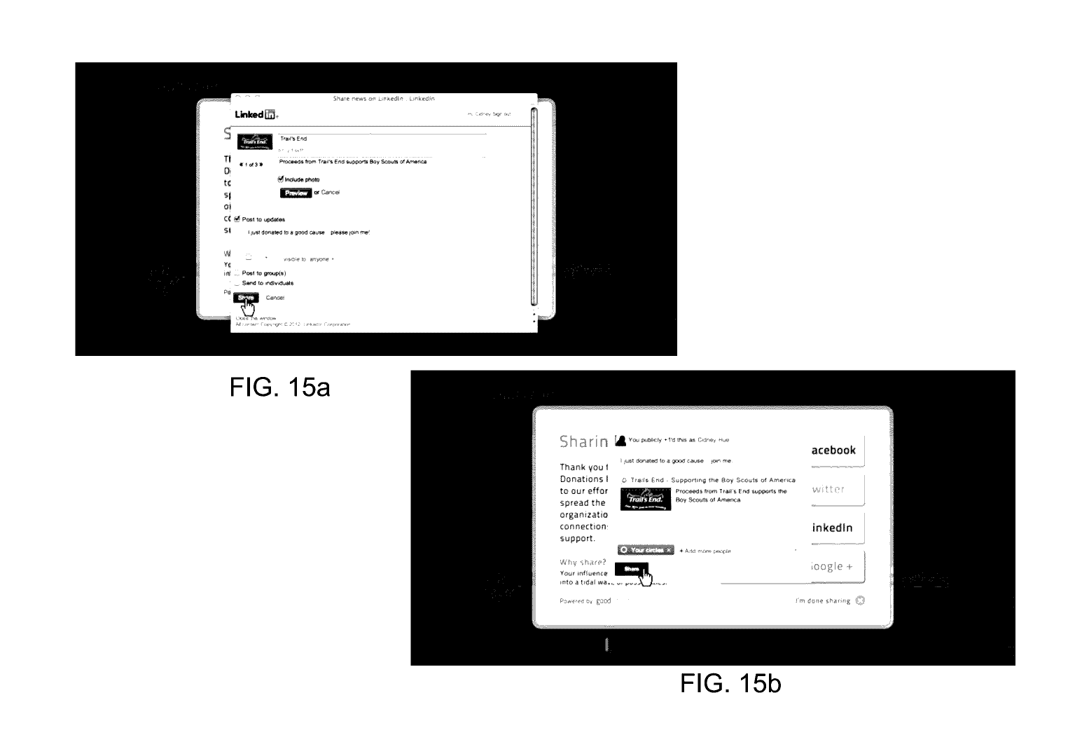

FIGS. 15a and 15b are additional examples of facilitate boxes that may be found on such social network sites as Linkedin and Google+, receptively.

### A/B and Multivariate Testing—Facilitate Stage

As noted, in an embodiment of the present disclosure, various forms of testing (e.g., A/B, multivariate) can be used in the facilitate stage 200 (Stage 2) to test variations of the content to determine which maximizes the results within the accumulate stage 300 (Stage 3). In an embodiment, the system is designed to dynamically alternate various versions of the content in real-time and measure which version drives the greatest results so that the organization can use the most effective version.

### Use of Parameters—Facilitate Stage

In an embodiment, an organization can capture parameters from the motivation stage 100 which can then be passed along and added to the content within the facilitate stage 200 (e.g., names, product information, donation amounts, goals). As a result, that information can be posted to the customer's social media wall. This in turn causes further personalization of a post and drives greater or higher conversion rates.

### Accumulate Stage

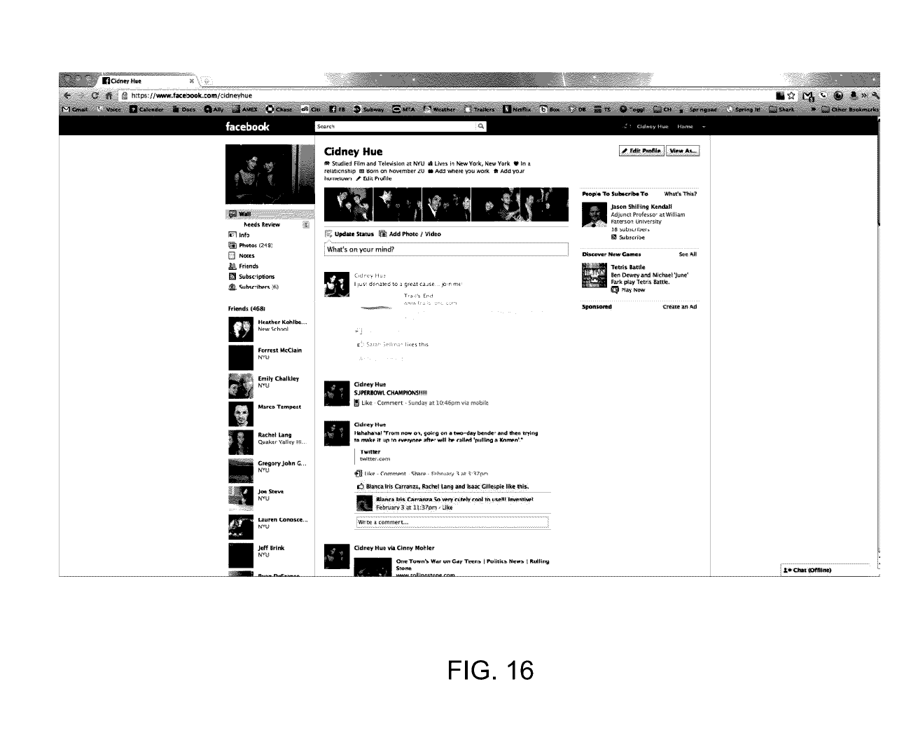

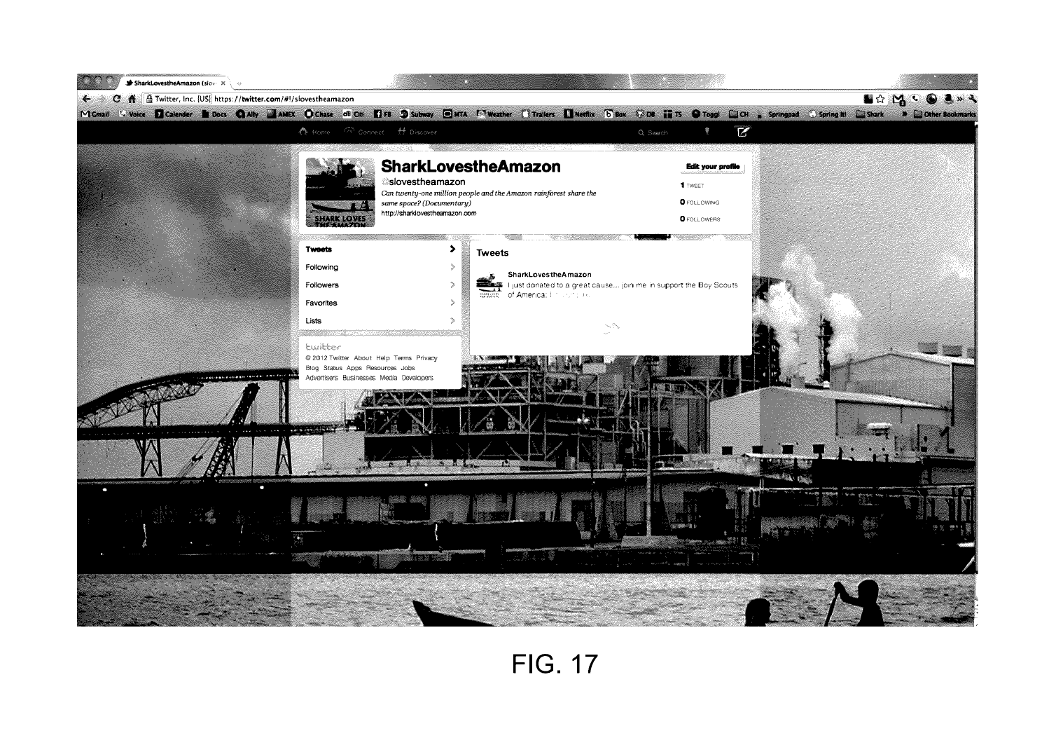

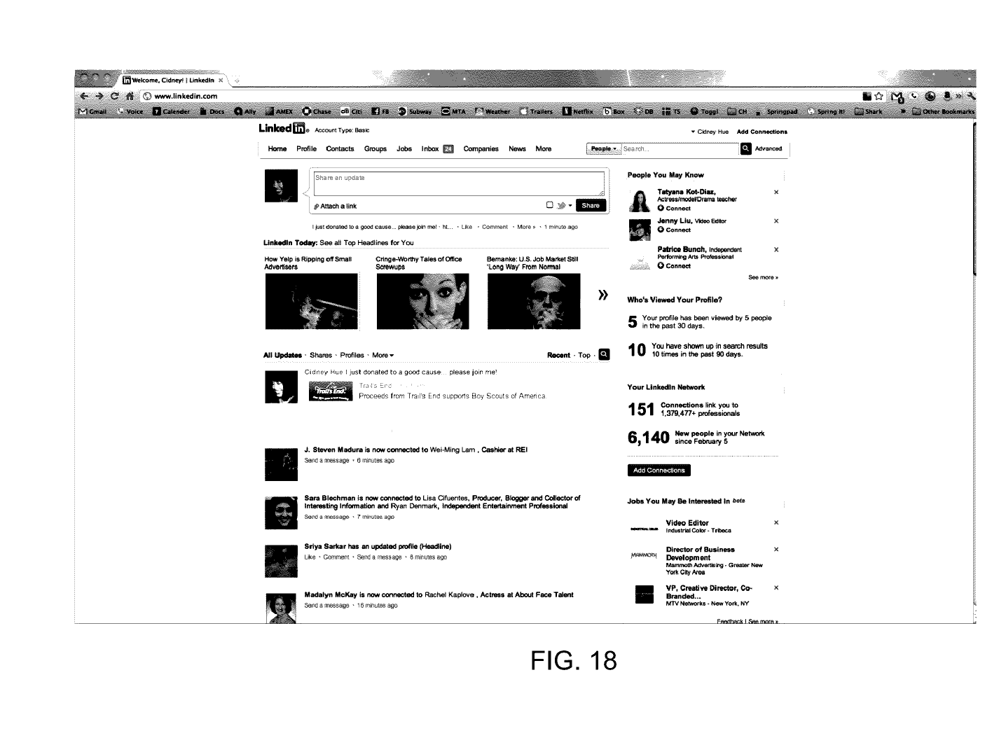

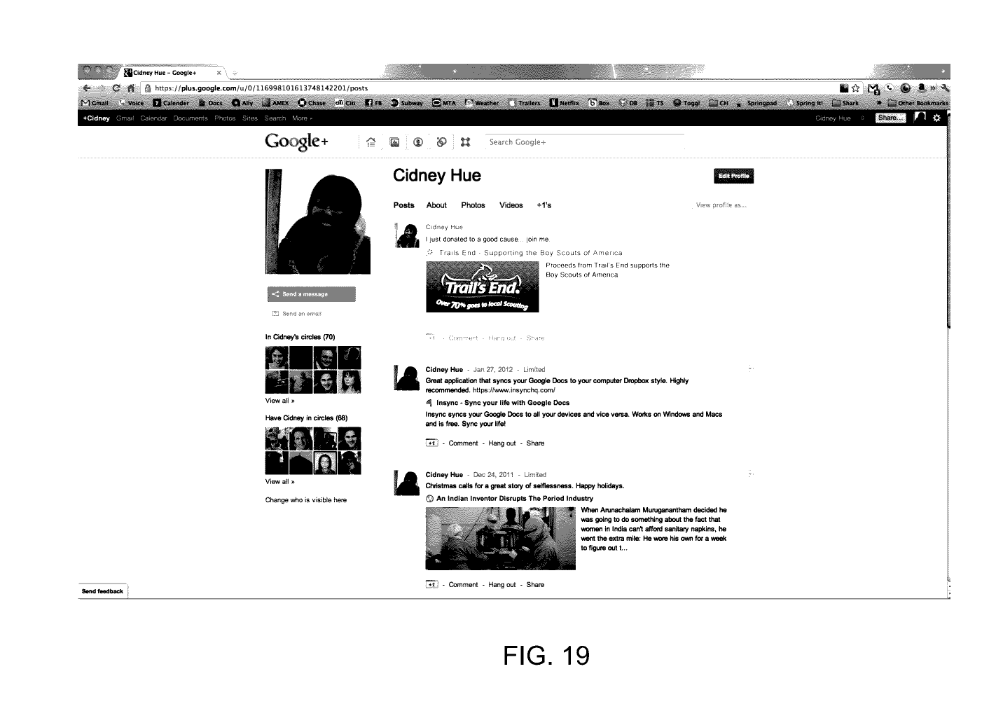

The third stage of the system is the accumulate stage 300. During the accumulate stage 300, the system is designed to maximize the number of social media connections who select the link 1304 and ultimately turn into incremental conversions. Maximizing the accumulate stage 300 is the primary driver for the system. As understood, the goal of the system technology platform is to drive a lift in conversions (i.e., brand awareness, brand engagement, purchases, donations, registrations). In an embodiment of the present system, the accumulate stage 300 starts with a customer's social media connections seeing the customer's post from the facilitate stage 200. FIGS. 16-19 are examples of social media post experiences by a customer's social media contacts on popular social media sites.

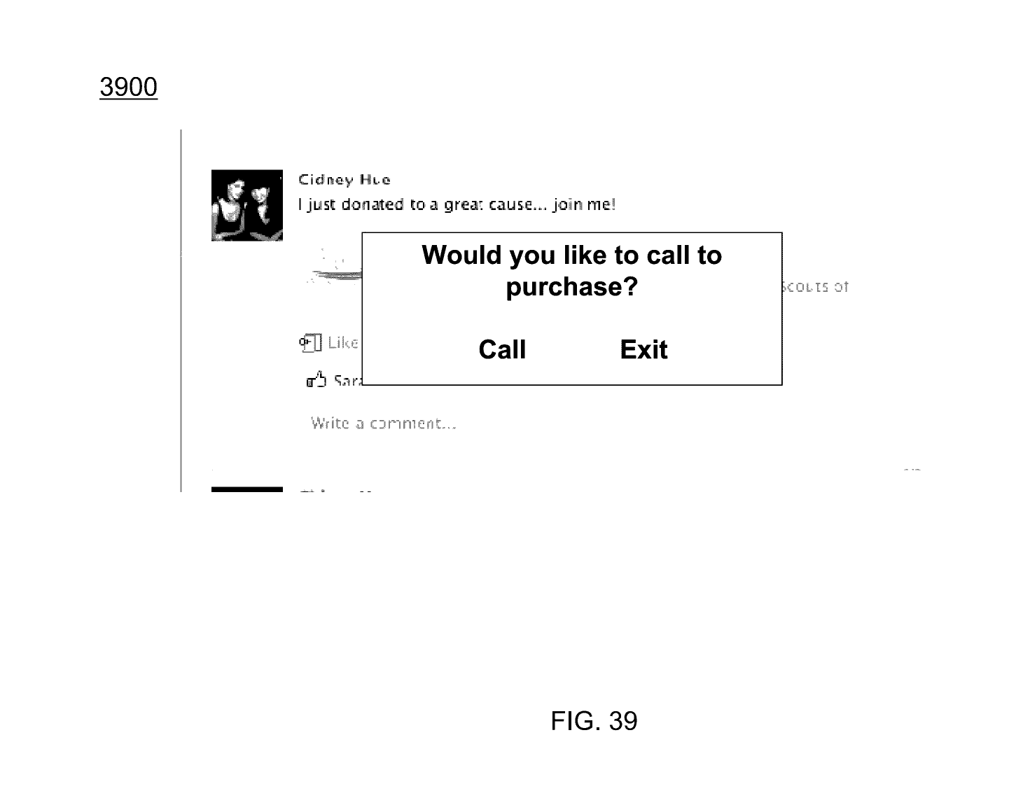

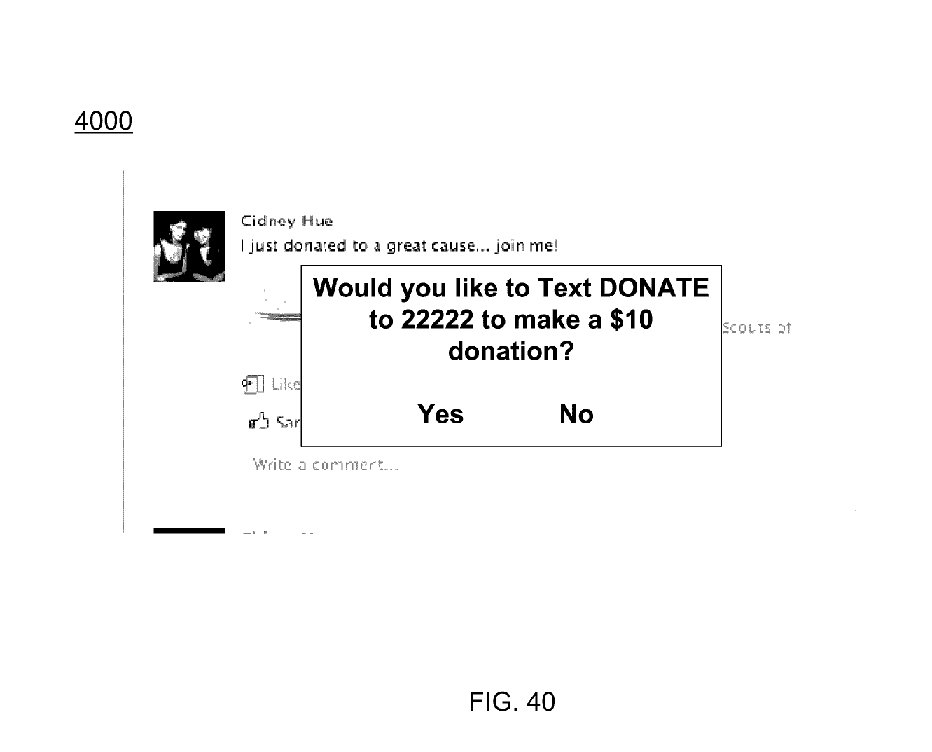

In the accumulate stage 300, an objective is to motivate and/or inspire the maximum number of a user's connections to click on the unique link 1304 in order to increase conversions. When they click on a link, they can be taken to learn more about the organization or product, or directly to convert. Or, if clicking on the link from a mobile device, they can be first prompted with a number to call or a text message they can send in order to learn more or convert. All of these actions can be tracked within the system. FIGS. 39-40 are examples of the how the system can detect in real time whether a connection is using a mobile phone to browse. If so, the system can automatically serve up a dialog box that will enable the connection to leverage the benefits of having a phone (e.g., calling, text messaging). So, this would create a better user experience for the connection and drive them to take action as easily and quickly as possible.

Next, the goal is to motivate and inspire those referrals to convert (perform the organization's desired user actions) at the highest possible rate.

### A/B and Multivariate Testing—Accumulate Stage

In an embodiment, various forms of testing (e.g., A/B, multivariate) can be used during the accumulate stage 300 to test variations in landing pages, i.e., the pages that a user's social media contacts arrive at after clicking on link 1304, to determine which landing page maximizes the conversion rate. Social media connections that click on the dynamically generated link 1304 during the accumulate stage 300 are routed through the system router and then forwarded to the appropriate landing page as determined by the organization. As part of the platform, the organization is able to predetermine a series of landing pages and elect what percentage of traffic should be routed to each page. This allows the organization to test multiple variations of pages and identify, in real-time, which page delivers the highest rate of conversion.

### Example

| Route | Landing Page | Percentage of Traffic | Conversion Rate |
|---|---|---|---|
| A | www.xxxx1.com | 25% | 10.25% |
| B | www.xxxx2.com | 25% | 29.75% |
| C | www.xxxx3.com | 25% | 40.00% |
| D | www.xxxx4.com | 25% | 20.00% |

The organization can also test whether mobile users would convert at a higher rate if they were to click on the link and be directed to a landing page or if they were prompted to call a phone number or prompted to use text messaging.

### Conversion Page

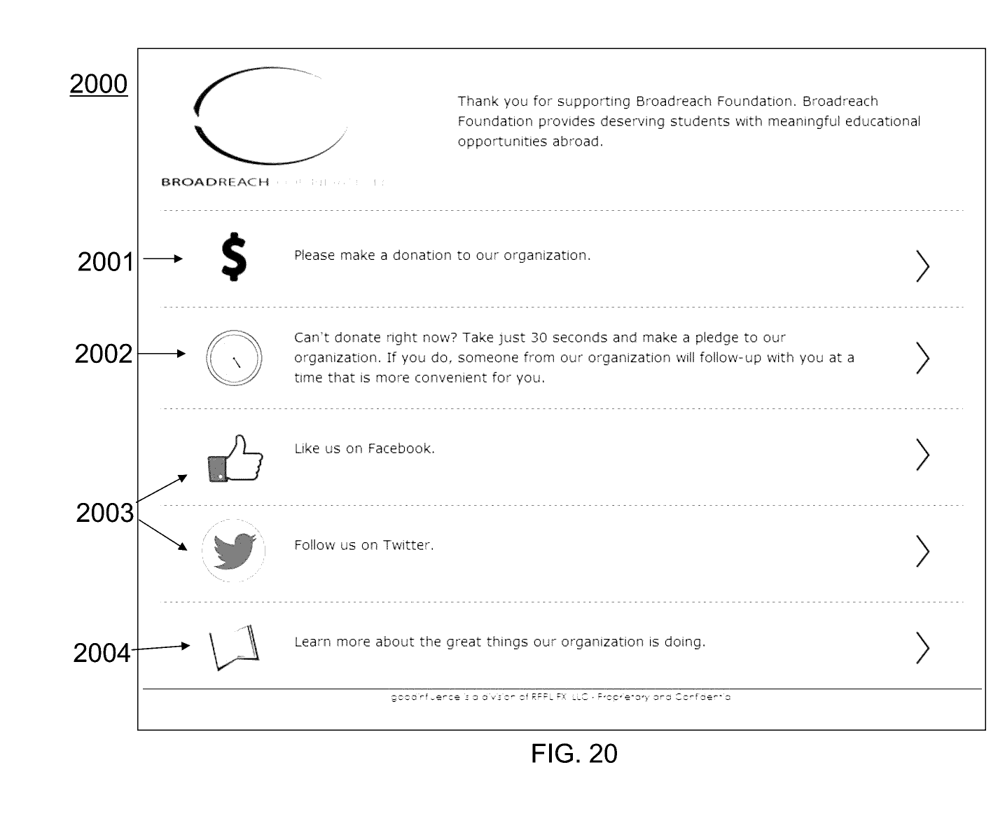

In an embodiment, as part of the accumulate stage 300, there is an optional conversion optimization feature called a “Conversion Page”. FIG. 20 depicts a typical Conversion Page in accordance with the present disclosure. As seen in FIG. 20, the user's social media contacts (User B) are directed to Conversion Page 2000 when they click on link 1304. Conversion Page 2000 contains several options for a User B (a second level user) to choose from. In this example, User B can choose to contribute 2001 to the organization, to contribute later 2002, to follow on various social media platforms 2003, or to obtain additional information 2004. It is to be understood, that the Conversion Page 2000 can be configured with more or less or different options. As seen in FIG. 20, Conversion Page 2000 is shown with respect to a charitable organization, however, it is not so limited. Conversion Page 2000 can be from a commercial vendor, a political organization or supplier wishing to sell additional goods or services, and my offer such additional choices as to purchase a specific item, see a selection of all items, etc.

In an embodiment, Conversion page 2000 may reside between the system router and the organization's website, although other system configurations are possible. When the Conversion Page 2000 feature is enabled, a user or second level user that clicks on a system link 1304 within the social media networks is routed to the Conversion Page 2000 page which acts to quickly and effectively route them to their desired location and/or quickly drive a range of conversions. Conversion Page 2000 is database-driven in real-time. In an embodiment, and as a result, it is completely customizable by an organization and can have an unlimited number of desired user actions. In addition to driving users to a desired location more quickly, Conversion Page 2000 allows the organization to drive and measure a broader range of conversions. The system technology platform can measure every interaction with Conversion Page 2000—providing organizations with more data to understand their prospective customers and the desired user actions of those prospective customers.

### Tracking Through the Use of Unique Links and Cookies

In order for the system platform to measure conversions, a unique link is created and assigned, based on the original customer who shares via the system platform during the facilitate stage 200. The link 1304 in FIG. 13 is an example of the unique link created by the system. This link may be shown to the user as a separate link as depicted in FIG. 13 or the link may be a text hyperlink within the text show in FIG. 13. Either way, this link enables the system to uniquely identify both the organization and the customer. In an embodiment, the system may apply a first party cookie when a customer's connection (User B or second level user) clicks on the dynamically generated unique link 1304 and gets routed through the system router. When User B later converts on the organization's website, the system platform, using the cookie, is able to determine whether that conversion came through the system link 1304 and the primary user A that was responsible for the referral. In an embodiment, the cookie, or similar informational code, can be set to last for a predefined period of time (e.g., 30 days). In such a configuration, if User B comes through the system link 1304 and does not convert, but comes back to the organization's website within that predefined period and then converts, the system platform can still identify that as a conversion that resulted from the system technology and the system link 1304.

### Demonstrate Stage

The demonstrate stage 400 or fourth stage of the system platform is designed to provide organizations and customers with all of the real-time and historical results data collected by the system platform.

The system may include a reporting system that may include at least the following elements:

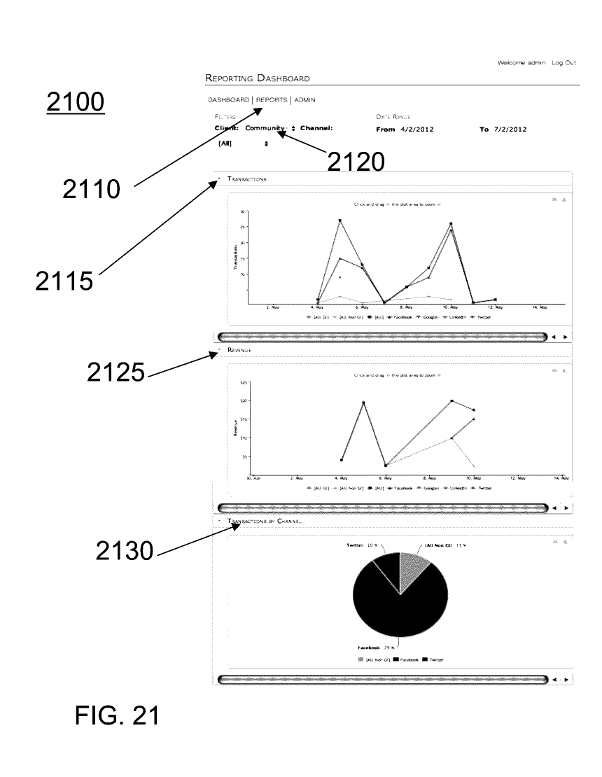

Dashboard—the dashboard may provide a quick snapshot of results. This enables an organization to easily understand the results being generated and driven by the system technology. FIG. 21 is an example of a possible system dashboard 2100.

Reports section 2110 can provide the organizations and its customers with a deeper view into the data. Reports can be fixed (standardized) in the system or be custom designed by an organization to fits its particular needs. As seen in FIG. 21, reports can include the number of transactions, 2115, from a particular community 2120, the amount of revenue 2125 generated from each sharing interaction and the number of transactions by channel 2130 or transactions per social media outlet. Once a custom report is created, there will be an option to save them in the system for future use and/or have them automatically run on a periodic basis as determined by the organization. Once run, reports can be printed or the data can be exported for use within other software packages (e.g., Excel, Access). In an embodiment, the reports provide the ability to sort and manipulate the data in any fashion the user needs. In an embodiment, some typical reports can include:

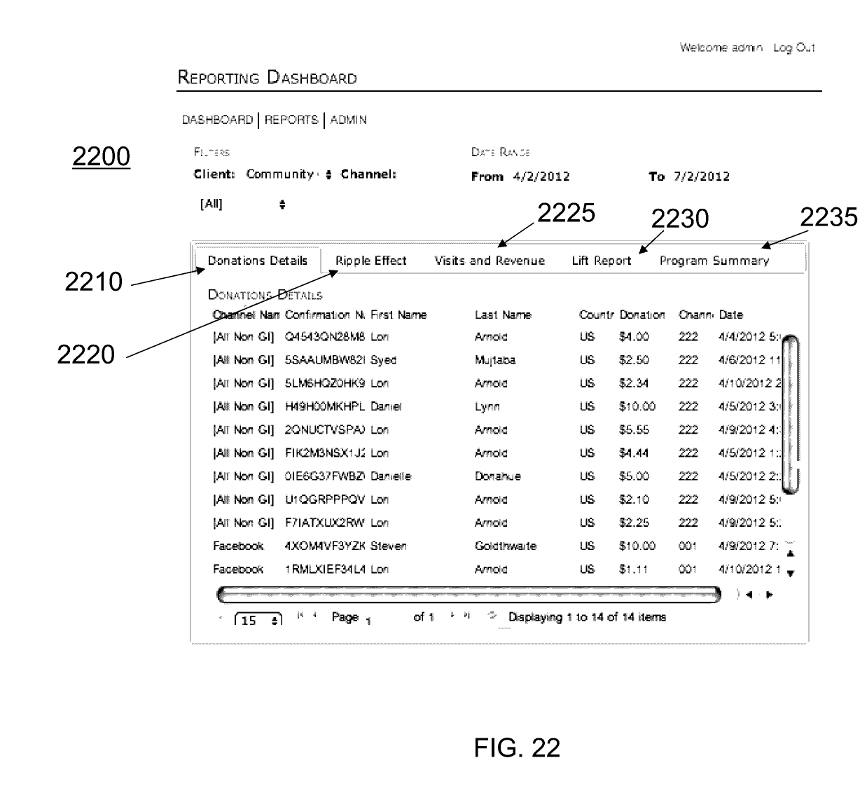

A Conversion Detail report as seen in FIG. 22. Report 2200 provides the details of each conversion driven through the System platform and provides the details of donations made to a particular organization. Donation tab 2210 details the specific donations or amounts spent per conversion including name, date and amount. Ripple Effect tab 2220 may be used to show the ripple effect of a particular users sharing activities. Visits and revenue tab 2225 may be used to show the number of visits made to the site and the revenue generate. Lift reports tab 2230 is used to display lift reports and Summary tab 2235 provides a program summary. As will be appreciated by those skilled in the art, the number and types of tabs available via the reports page is not limited to those shown, but can be configurable based on the information sought.

The Ripple Effect (also known as Leaderboard Reports) report provides the ability for the organization or the customer to view an individual's influence and impact across various social media outlets. In an embodiment for example, if a customer purchases something for $100 and then asks their social network connections, via the system technology platform, to join them and make a purchase, the customer and the organization will both be able to see who took that action and how many purchases resulted. The customer will be able to see the results generated by their own personal influence. This will include the ripple effect associated with their influence and then the influence of their connections. In an embodiment, the customer and organization will be able to see the results from their connections (wave 1 or ripple 1), then from the connections of their connections (wave 2 or ripple 2), then from the connections of the connections of their connections (wave 3 or ripple 3), and so on.

This Ripple effect view provides for a powerful new way to look at the data and understand the influence of individuals and the ripple effect of a message across social connections. Such positive reinforcement serves to further motive a user into utilizing future sharing opportunities. The ripple effect report allows an organization to rank the results by the customer influencing the most conversions. As a result, it may allow the organization to reward that user, if desired. Such rewards may include recognition, coupons, point of sale discounts, rewards program incentives, products, services, etc. In an embodiment, the report may also provide a customer's results relative to a goal that customer may have set during the motivation stage 100.

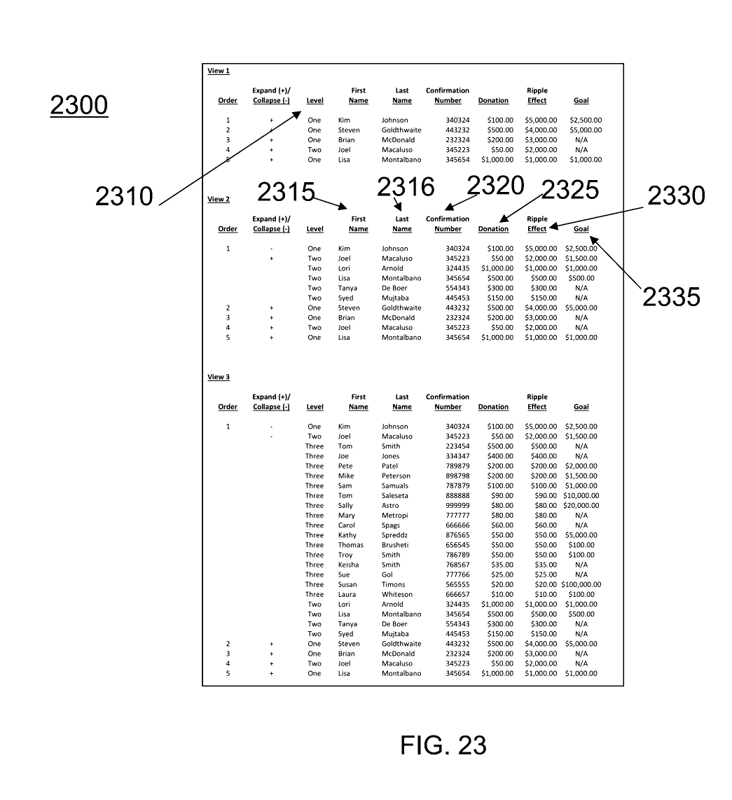

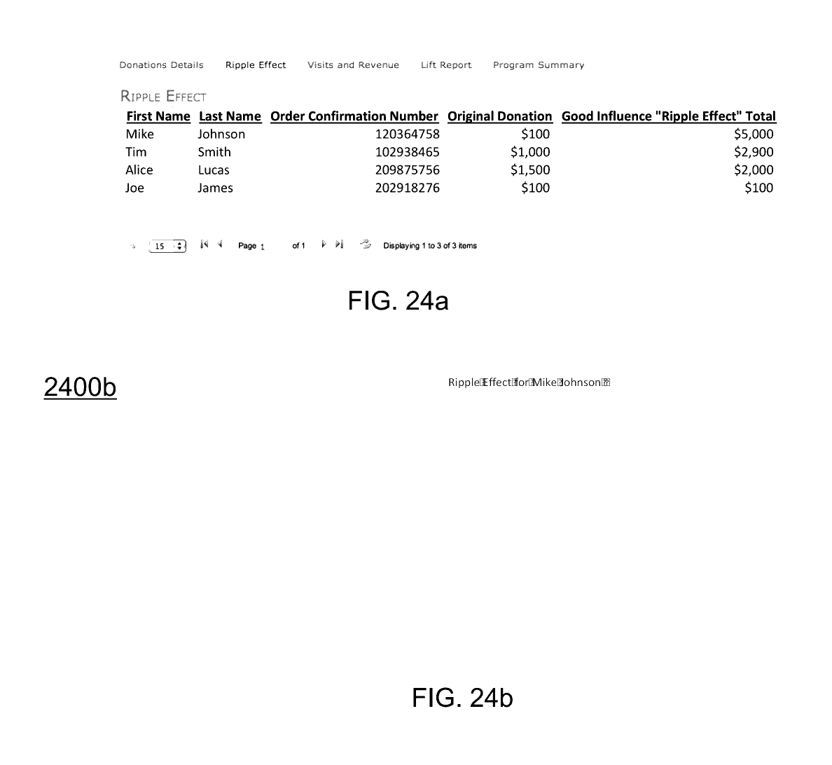

FIG. 23 is an example of one type of Ripple Effect Report 2300 or Leaderboard Report. Ripple effect report 2300 provides several views 1-3 of the proliferation of the endorsement and ripple impact of a particular customer or donor. Level column 2310 indicates the level of connection between the original user and the new donor. As seen in level column 2310 indicates a direct connection (Level One, Wave One, Ripple One), a secondary connection (Level Two, Wave Two, Ripple Two—i.e., a connection of a connection), and level three (Level Three, Wave Three, Ripple Three—i.e., a connection of a connection of a connection). Name column 2315 and 2316 include the new user's name, confirmation column 2320 indicates the unique transaction ID (also known by such names as Confirmation Number, Order ID, Transaction Number, etc.) assigned by the organization to that user's conversion, donation column 2325 includes the user's donation or purchase amount, ripple column 2330 indicates how much that user's social media contacts have generated as a result of, in this case, the donations of their connections and goal column 2335 is the goal set by the user. FIGS. 24a and 24 b are alternative examples of a Ripple Effect Reports. As seen in FIG. 24a, the information available in report form is customizable and completely configurable. Ripple report, 2400b provides an additional/alternative view of ripple report information. As graphed in Report 2400b the total amount of each level of connection can be graphed to display a simpler view of a user's impact via social networking. Each bar shows the results for each level of connection (also referred to as Wave, Ripple, Level, etc.). If the report user clicks on a bar, a report showing the data that makes up that bar is presented to the user.

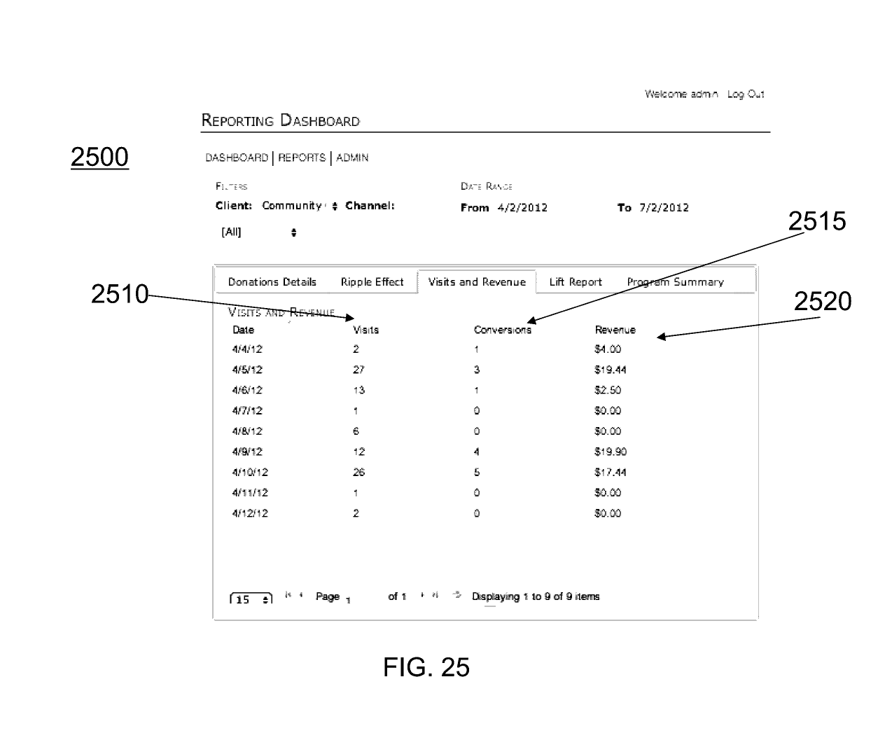

If a user wishes to review a Visits and Revenue Report from the reports page 2200, they can link through tab 2225. The visits and revenue report provides a summary of the total number of visitors within a particular timeframe and the conversions and resulting revenue that occurred from that transaction. (Assuming it is a revenue-based conversion. It should be noted, however, that in an embodiment, the conversions do not necessarily need to be revenue-based and could for example, the number of surveys completed or the number of downloads of an items or the number of comments on a topic. A conversion is whatever is the organization's desired user action). FIG. 25 is a typical visits and revenue report 2500. This displays the number of visits 2510 by others, generated as a result of a user's sharing and the actual number of conversions 2515 that occur as a result of those visits and the respective revenue generated 2520 as a result. As noted above, revenue is not the only thing traceable, and this information could include any desired user action.

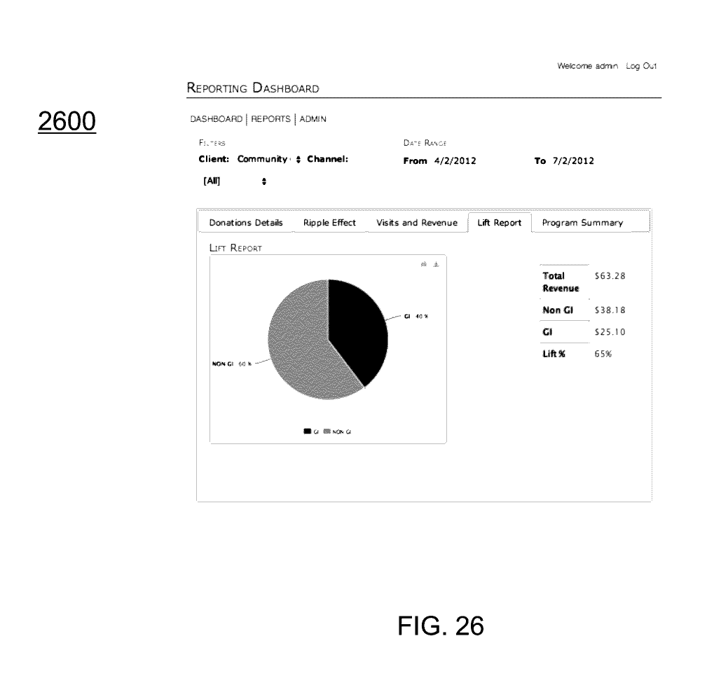

FIG. 26 shows a lift report that might be generated if a user were to click on the lift tab 2230. This report shows the actual “lift” in conversions and revenue (in the case of a revenue-based conversion). This enables the organization to quickly and easily understand the actual business impact of the system technology. As seen in Lift report 2600 the user is able to see all of the organization's conversions—whether generated through the system or not. The user is then able to see separately all conversion not generated through the system and all conversions generated through the system. As a result of having that data, the system is able to determine the incremental lift attributable to the system.

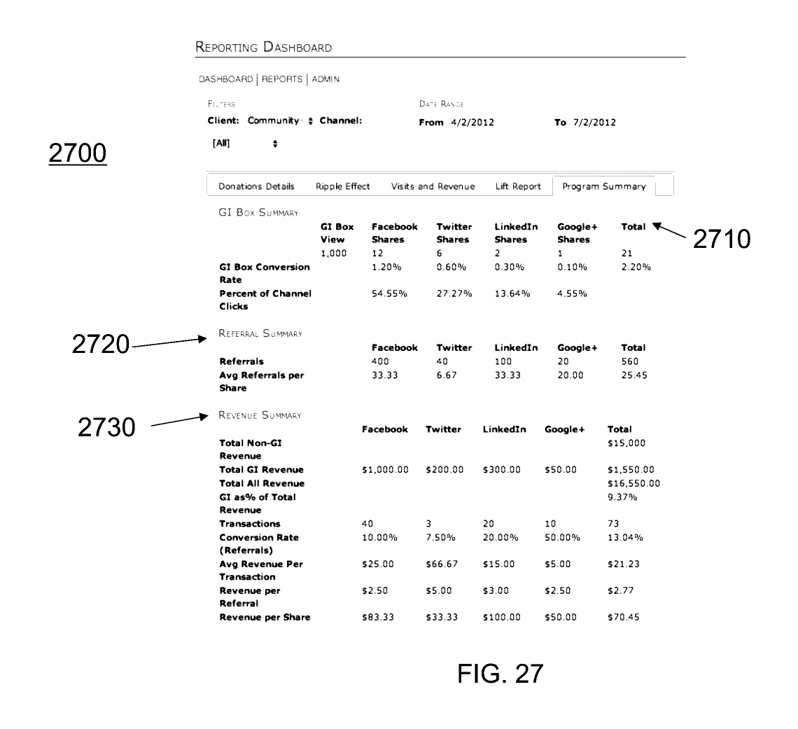

FIG. 27 depicts a program summary report 2700 in accordance with an embodiment of the present disclosure. Program summary report 2700 can provide an organization with a quick but detailed view of the results across every stage of the system (Stages 100, 200, 300 and 400) over a chosen period of time. The information in section 2710 shows, of the number of users engaged by the system at the point of conversion, how many were willing to share with their social media connections. It also shows which channels they shared on and what the total share rate was. The system will also be able to show how much awareness was generated as a result of the sharing—whether a connection responds or not. The information in section 2720 shows how many connections responded as a result of the sharing and which social media channels provided the greatest response rates. Section 2730 shows the revenue impact (if a revenue-based program) and conversion transaction impact. This can include the total revenue and transactions without the system and the total incremental revenue and transactions as a result of the system.

### Goal Setting

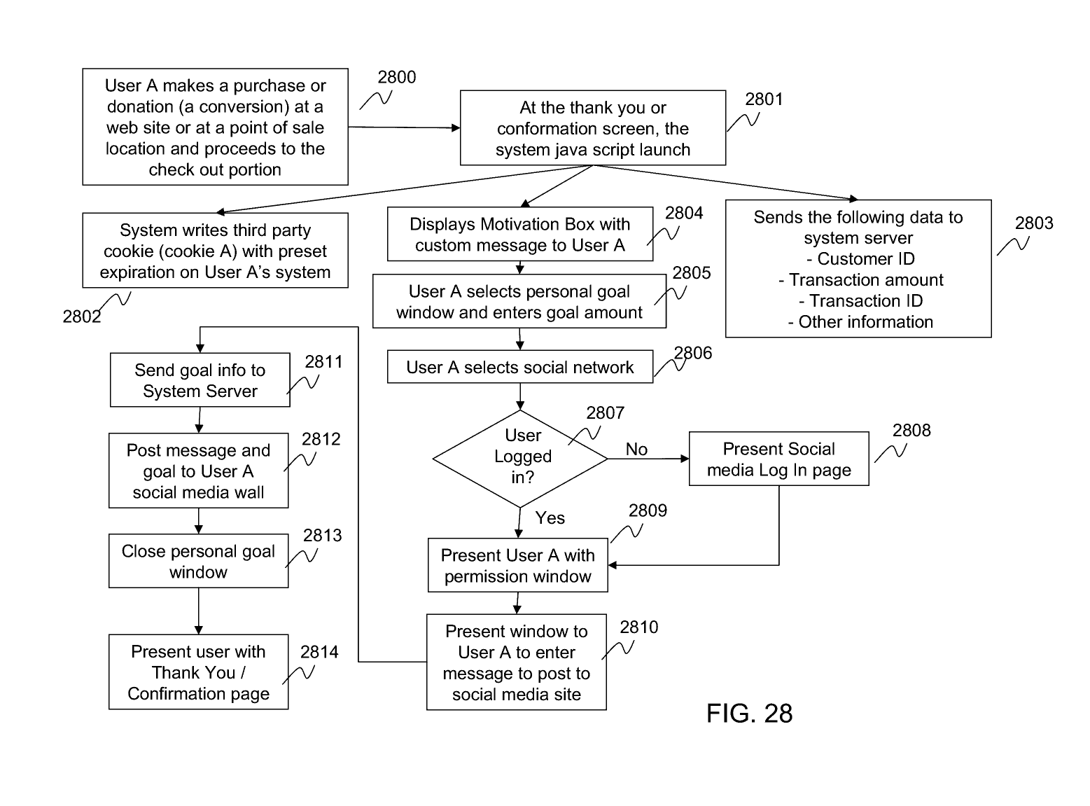

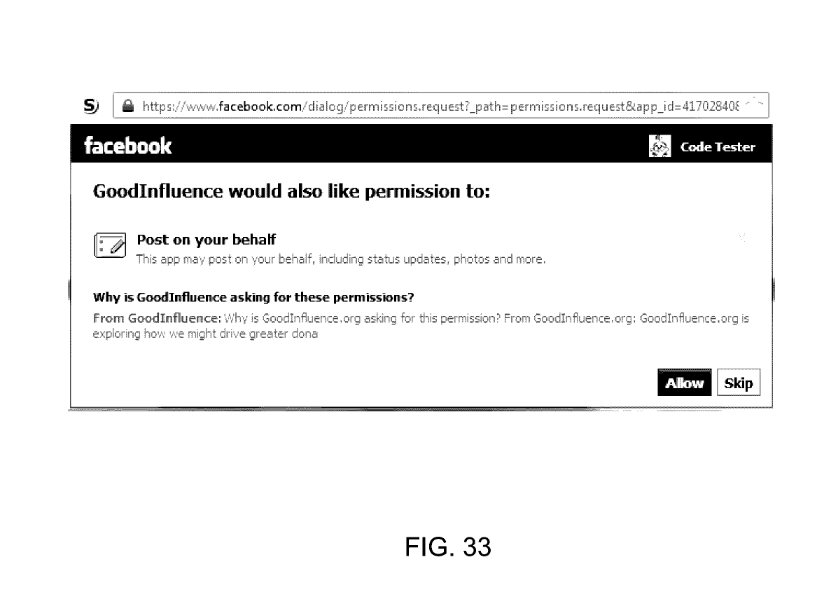

Goal Setting is a feature of the present system designed to drive greater results. Goal Setting enables the customer to set a goal and share that goal with their social media connections. It has been determined that a connection (User B) is more likely to take action in order to help a customer (User A) achieve their desired target. FIG. 28 depicts an example in an embodiment of how goal setting works within an embodiment of the platform. At step 2800 User A goes to an organization's website (or any conversion point) and makes a donation/payment. At step 2801 once User A reaches the Thank You/Confirmation page the system imbedded (client-side) code does the following: at 2802 it writes a third party cookie (cookie A) on User A's computer (with a preset expiration date, such as 30 days). At step 2803 the imbedded code sends the following data to System server: System customer ID; dollar amount; unique transaction ID; and other information, such as, but not limited to, name or email, promo code, etc. At step 2804, the system motivation box with the organization's customized message to motivate the user to set a personal collection goal and share their conversion on a social network is produced. At step 2805, user A, sets a personal goal in the Personal Goal Window by selecting a personal goal amount. At 2806 User A selects a social network. At 2807, if User A is not logged into the selected social media site, the user is prompted with a social media login screen at step 2808. If User A is already logged into their selected social media site, he or she progresses to step 2809 where he or she is prompted with a social media permission window. A social media permission window as seen in FIG. 33 allows the system to post on the User's behalf on the social media site. This permission to post typically expires in a preset period of time, or the user can go into the user's settings and remove the system permission anytime.

At step 2810 the social media site presents a window to User A allowing user A to enter the text of the message to be shared (see FIGS. 13-15). Once the message is complete and User A is finished with his or her post, the personal goal amount set in step 2805 is sent to the system server at step 2811 and User A's post is made to the user's social media “wall” at step 2812. At step 2813, the personal goal window closes and at step 2814, the user is presented with the organization's Thank You/Confirmation page.

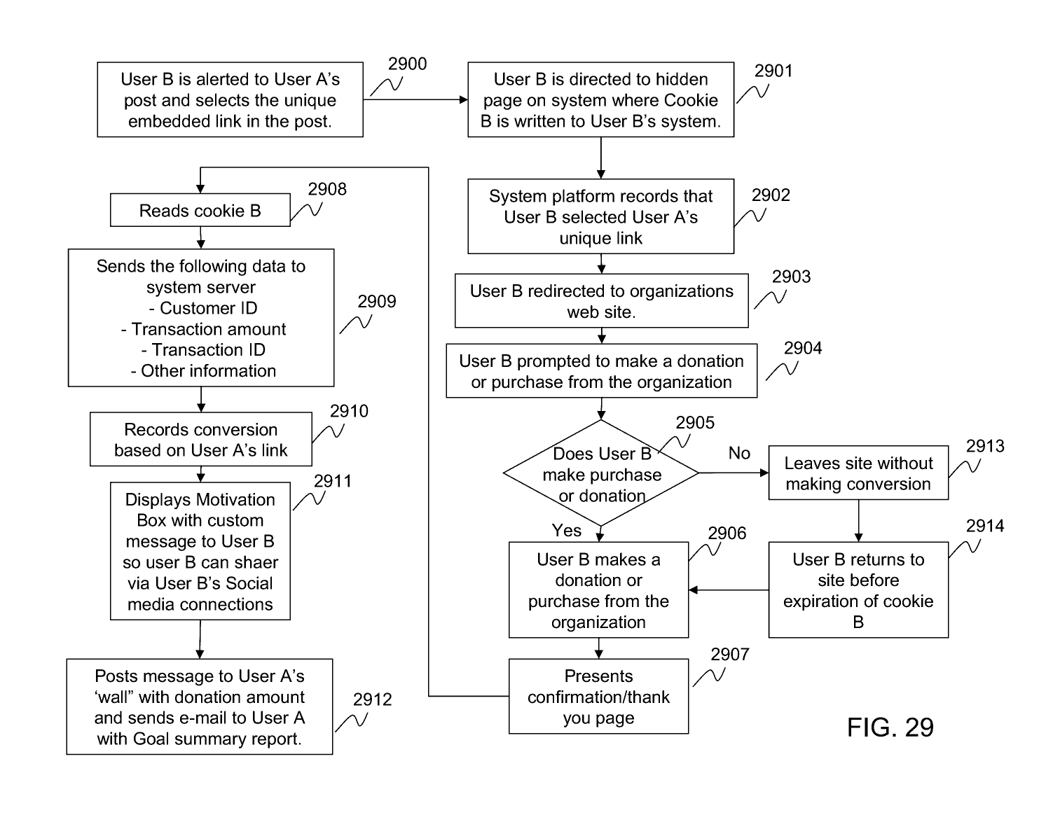

FIG. 29 depicts a flow chart of how a secondary user, User B, responds to User A's post. At step 2900, User B sees User A's post on their social media site and selects the embedded link in the post. This link is a unique to User A and is typically, a dynamically generated bit.ly redirect URL that goes to a hidden page generated by the system of the present disclosure. At step 2901, user B is directed to the hidden page on the system. A third party cookie (cookie B) is written to User B's system with an expiration date (typically, 30 days, but could be anything). At step 2902, the system platform records in a database that User B clicked on User A's unique link. At 2903, the hidden system page redirects User B to the organization's website. The redirection and placing of the cookie all happen without User B's knowledge. At 2904 User B is prompted to makes a donation or purchase from the organization's web site. At 2905, the system determines if User B makes a purchase and or a donation. If yes, then at 2907 the organization presents a thank you and/or a conformation page. During the conformation of step 2907, the system 2908, reads cookie B and gathers data at 2909 to send to the system sever on user B. At 2910, User B's conversion is recorded and credited to User A's sharing and User A's unique link. At 2911, the system code displays the motivation box again with the organization's customizable message to allow User B to share on his or her social networks. At 2912, a message is posted on User A's social media “wall” with the donation amount that was made and an e-mail with a link to a Goal Summary Report is sent to User A. The Goal Summary Report can have user names or just a unique transaction ID. If at step 2905, User B leaves the organization's site without making a conversion, step 2913, but returns at a later time before cookie B expires, at step 2914, then User A will still get credit for the conversion based on the original posting.

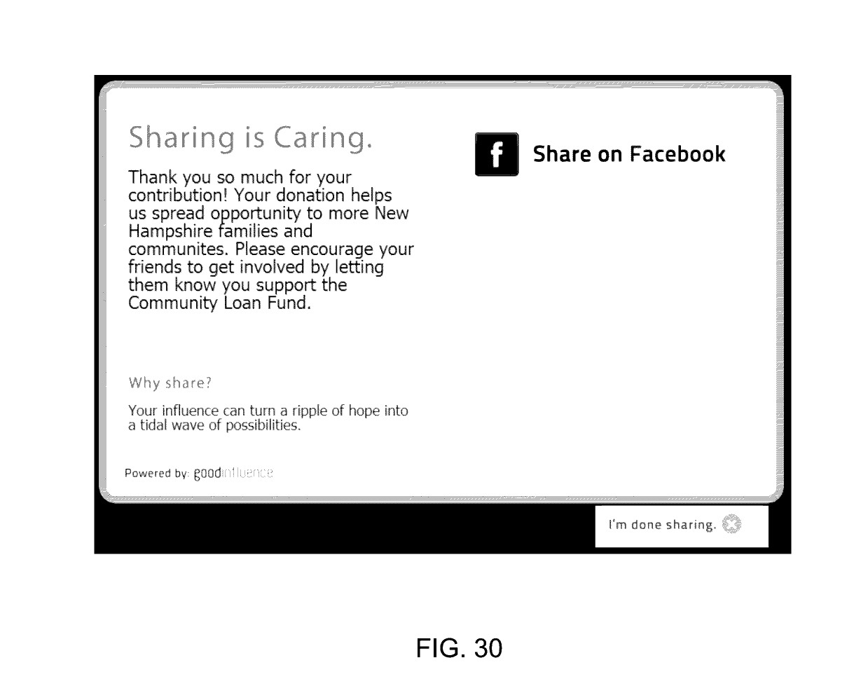

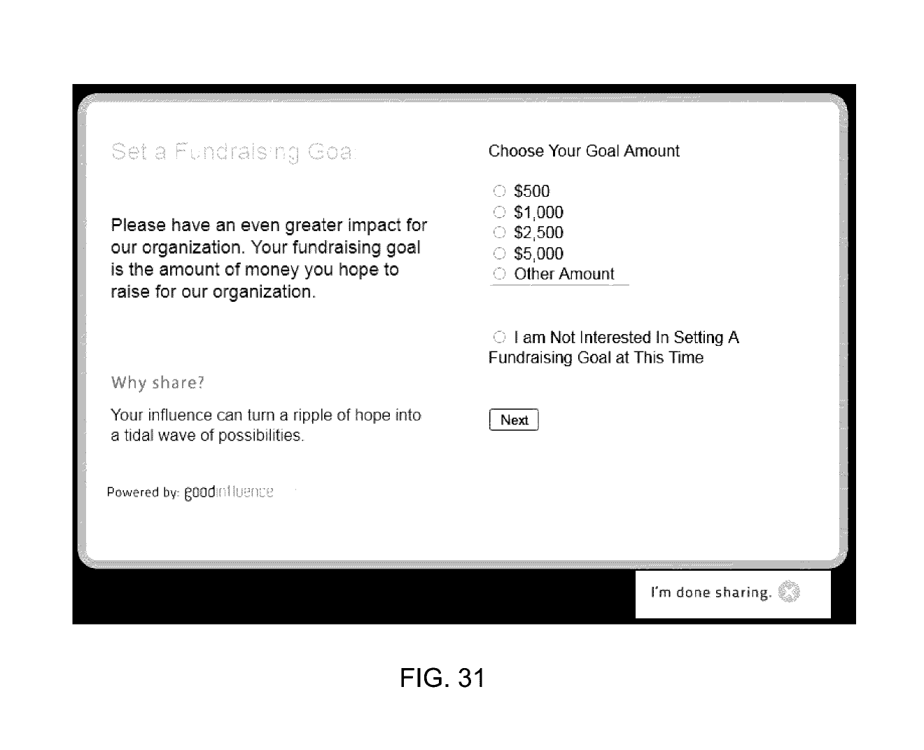

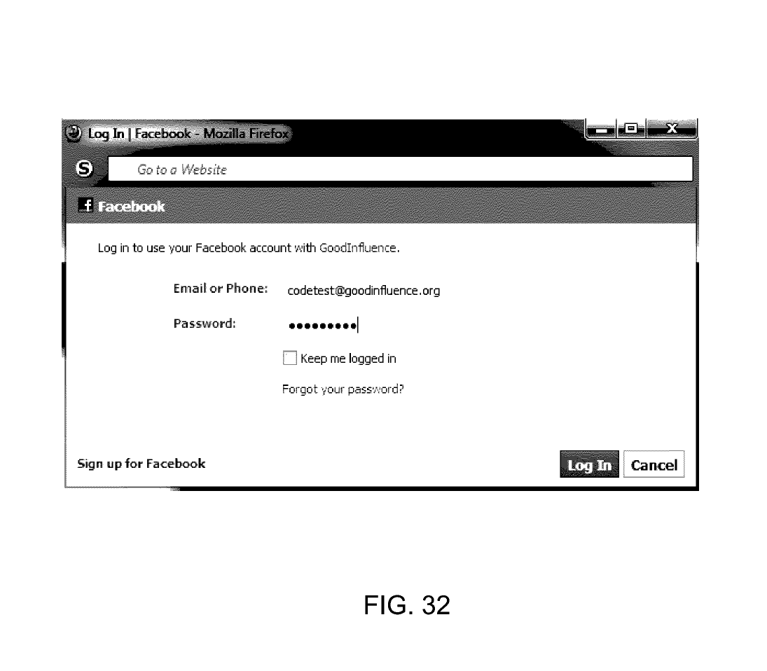

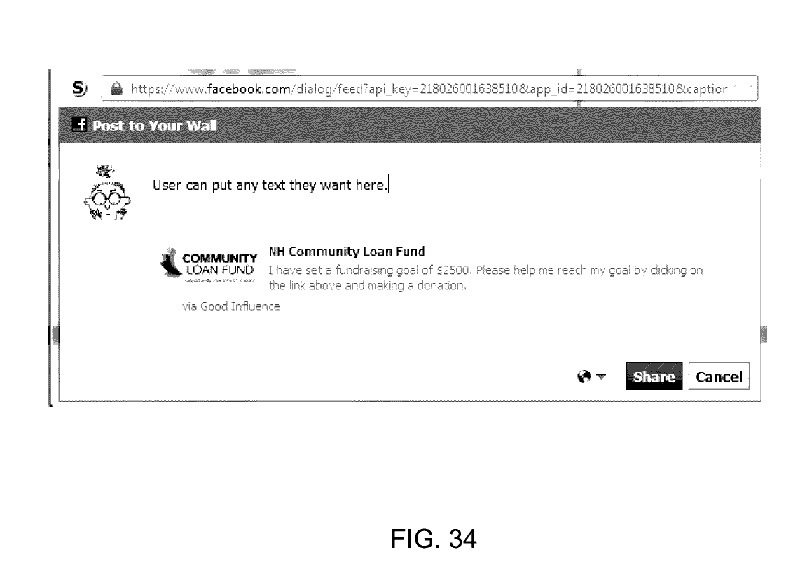

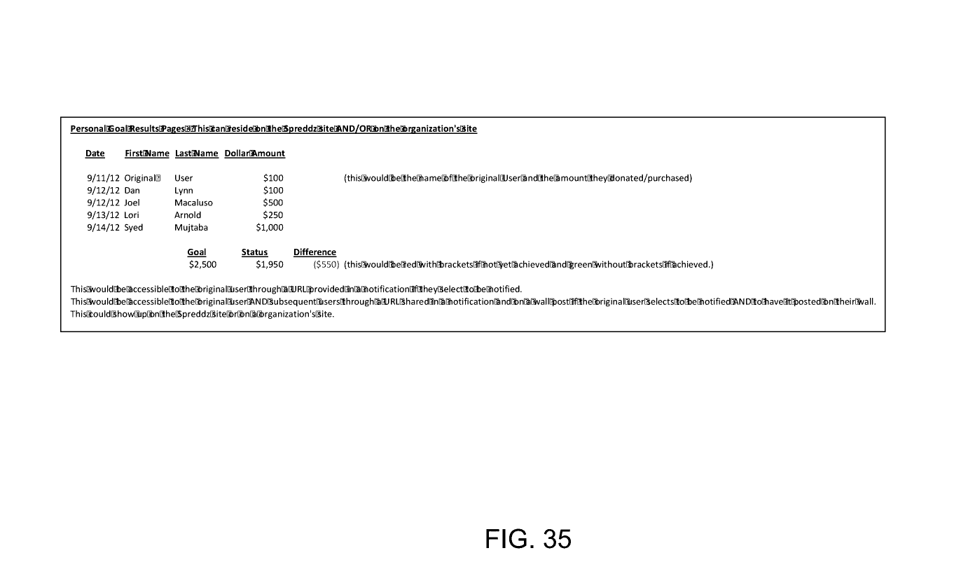

FIGS. 30-35 are views in accordance with an embodiment of the present disclosure. FIG. 30 is an example of a motivation box that may appear at step 2804 of FIG. 28. FIG. 31 is an example of a Personal Goal Setting Screen that a user may see at step 2805 after agreeing to share their conversion. FIG. 32 is an example of a social media login page a user may encounter after agreeing to share their conversion on their social media sites. (See Step 2808). FIG. 33 is a typical social media permission window that a user may see at step 2809. The permission window allows the system to post on the user's behalf to the social media sites. FIG. 34 is an example of a typical post window for a social media wall (Step 2812). FIG. 35 is a Personal Goal Setting Report that shows a user a summary of all the subsequent conversions and the ripple effect resulting from the posting of their goal.

### Mobile Device Features—Phone Number, Lead/Pledge Form

The system contains several features that enable more interaction with users on mobile devices.

The first mobile feature (FIG. 39-FIG. 40) enables connections, using a mobile phone and clicking on the user's unique link posted on the social media channels (Stage 3), to be prompted to call a phone number. The system automatically determines whether a user is engaged with the system via a mobile phone device. And, if this feature is enabled, the system or phone will prompt the user with a dialogue box asking them if they'd like to use their phone to call. If not, the user is taken through the standard process. If yes, the user is directed to a call center.

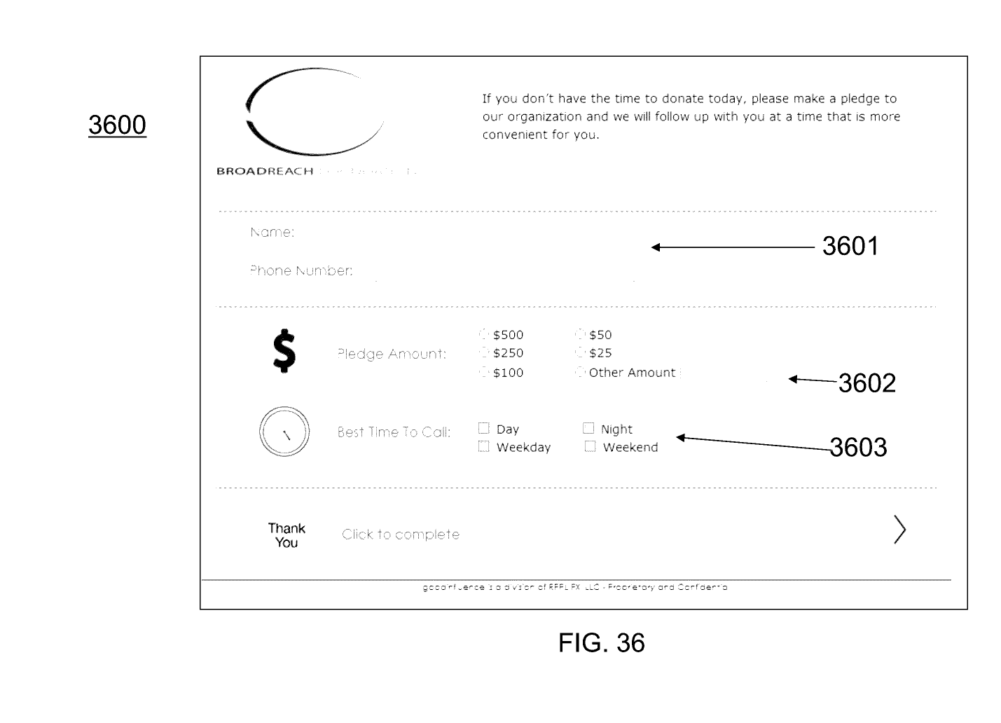

The second mobile feature is the Lead/Pledge Form. This is a feature of the system platform is designed to capture preliminary conversion information from a customer's connections who are unable or unwilling to go through a full conversion process at the time of the original engagement. This could occur if a user is engaged with the system through a mobile device with a smaller screen that makes it more difficult to complete a transaction. Or, this could occur if a user is engaged with the system while traveling or with limited time and, as a result, wouldn't have access to credit card information or wouldn't have the time required to complete a transaction. While the Lead/Pledge Form can be used by any User B (as long as this feature is enabled by the organization), the Lead/Pledge Form capability becomes very important as more and more consumers interact with social networks via mobile devices. The Lead/Pledge Form is mobile friendly and allows an individual to quickly provide information that can be followed-up on by the organization at a time that is more convenient for the User B. User B lands on a typical Conversion Page after clinking on the unique system link located on User A's social media wall. FIG. 20 is a typical Conversion Page in accordance with an embodiment of the invention. As seen, a secondary user, such as user B is presented with several options to chose from. If user B decides to contribute later and selects the contribute later box 2002, then, the Lead/Pledge Form 3600 as seen in FIG. 36 is presented. The Lead/Pledge Form can be customized in any way the organization chooses. FIG. 36 illustrates some information gathering options, such as personal information 3601, pledge amount 3602, contact information 3603, but is not limited to only the fields shown. Other possible fields include, best way to contact, alternative numbers, e-mail addresses, send reminder option, etc.

In an embodiment, incentives in the form of points, dollars, discounts, coupons, badges, promotion codes, bit coins, rewards, or recognition may be used to increase user engagement and drive greater results throughout all four stages of the system platform.

User incentives to drive user engagement provide the capability for organizations of all types and sizes to reward consumers for sharing with their connections across social media. The platform will track actions, impact, or points that consumers earn for various levels of social sharing activity and, based on the actions, impact or points earned, organizations can award the users having the greatest results. This may be referred to as social gamification.

Incentives can be used as a way to motivate user engagement within any channels, platforms, interfaces or devices outlined above.

Users can also be motivated with incentives for spreading “content” across their social media connections including things such as but not limited to messages, videos, photos, images, links, or files.

In an embodiment, organizations or third-party providers can load content into the system or the content can be resident on a different system or hosted on a remote system or a third-party network and coupled to the present system via a network. The content may including but is not limited to messages, videos, photos, images, links or files. Content providers/selectors (i.e., organizations) will describe the benefits of the content and the reasons why users should be interested in sharing that content with their social media connections. The organizations will also be able to describe a reward that a certain number of users will get if they are able to spread the word about the content further than other users. In an embodiment, organizations can provide a start date and an end date for each “contest” or “campaign”.

Users are able to browse, search and select content within the system that they wish to share due to their interest in either the content or the reward or both. The system then engages the user to share, facilitates the sharing process, tracks and tabulates the points that each user accumulates for spreading the content across social media, creates leaderboard reports so that users and organizations can view the current leaders for each campaign, and provides the organizations with a list of the winners for each campaign.

In an embodiment, in order to track how far a specific user is able to spread content across social media in terms of measurements such as the number of shares, the awareness generated, the engagement driven, the incremental views and/or visits and/or conversions, users may be required to “Sign In” or “Create an Account”. In an embodiment, there are 2 classes of users, Individuals and Organizations.

In an embodiment, the content and incentives may be targeted to users based on demographics—including geography. As an example, in an embodiment, all campaigns are national by default, but the system may comprise a check box for organizations to use for local targeting such as local region or zip code. If checked, certain content may only display to users within a specific targeted geography. In an embodiment, the system may utilize an IP location, zip code location, GPS location, or other form to target specific users in specific areas. In an embodiment, the geography feature can be implemented to add a target region to select geography: Country>State>City>Zip Code->use IP address or GPS to determine the location of user, and serve only matching offers. For local region the system may determine device IP location (zip code) or a GPS for mobile, return offers that are within a radius within 20 miles of that location. In an embodiment, organizations are able to view all of their campaigns and the performance of each in aggregate or individually.

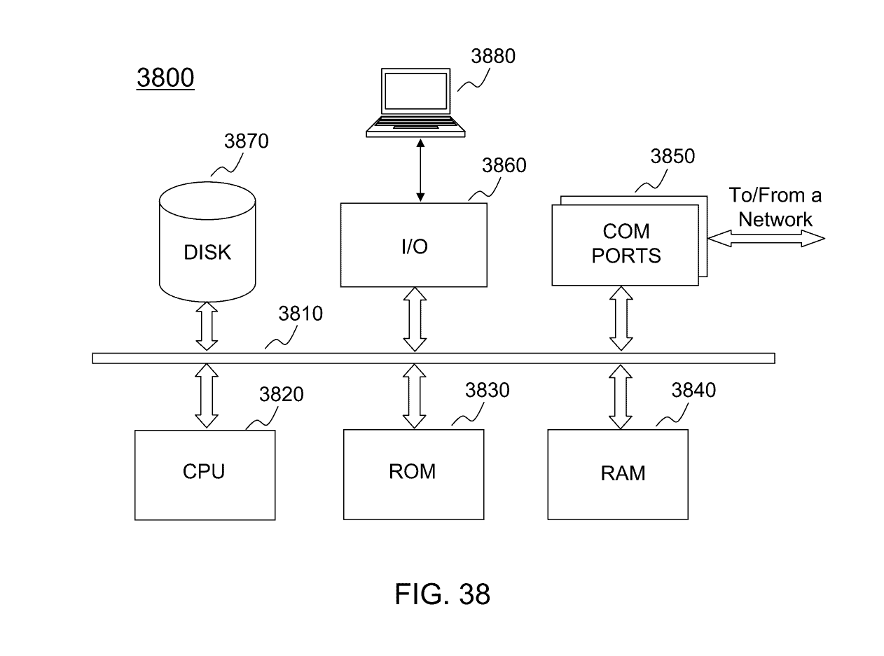

In an embodiment, as users seek to earn incentives, organizations can track, gather and report information related to the user's ripple through the social networking contact. As discussed with respect to user's conversions above, a user's spread of content creates a quantifiable ripple effect as the user's second, third, forth, etc, tier contacts continue to spread that content. This provides the organization with feedback regarding the content most likely to convey the desired message. FIG. 38 provides a functional block diagram illustration of a computer hardware platform, which includes user interface elements. The computer may be a general purpose computer or a special purpose computer. This system may be cloud based or distributed. Computer 3880 can be used to implement any components of the system sharing architecture as described herein. For example, the motivation stage 100, facilitate stage 200, and reporting stage 300 can all be implemented on a computer such as computer 3880, via its hardware, software program, firmware, or a combination thereof. Although only one such computer is shown, for convenience, the computer functions relating to conversions, motivating users, facilitating users, generating unique links, generating reports, may be implemented in a distributed fashion on a number of similar platforms, to distribute the processing load.

The computer 3880, for example, includes COM ports 3850 connected to and from a network connected thereto to facilitate data communications. The computer 3880 also includes a central processing unit (CPU) 3820, in the form of one or more processors, for executing program instructions. The exemplary computer platform includes an internal communication bus 3810, program storage and data storage of different forms, e.g., disk 3870, read only memory (ROM) 3830, or random access memory (RAM) 3840, for various data files to be processed and/or communicated by the computer, as well as possibly program instructions to be executed by the CPU. The computer 3800 also includes an I/O component 3860, supporting input/output flows between the computer and other components therein such as user interface elements 3880. The computer 3800 may also receive programming and data via network communications.

FIG. 39 depicts an exemplary dialog box of an embodiment of the present system, wherein the platform may detect in real time whether someone in Stage 3 of the system is using a mobile phone device to browse. If so, the system or phone can display a dialog box that will enable the user to leverage the benefits of having a mobile device. This allows for a better user experience for the user and allows for greater results for the organization. In the example depicted in FIG. 39, the dialog box 3900 provides the user with the ability to make a phone call in order to purchase the product rather than selecting or clicking on a link and visiting a website or going to a store.

Similarly, FIG. 40 depicts an exemplary dialog box of an embodiment of the present system, wherein the system is able to detect in real time whether someone is using a mobile phone device to browse. If so, the system may serve up a dialog box 4000 that will enable the user to leverage the benefits of having a mobile device. This too creates a better user experience for the customer and can lead to better overall results for the organization. In dialog box 4000, the user is provided with the ability to use text messaging to make a donation (or make any conversion) and have that charged to the user's phone bill (if it is a revenue-based conversion) rather than having to click on a link or make a call to continue through the process.

Hence, aspects of the methods of utilizing a user's social media connections to increase visibility of an organization may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a application server or host computer of a search engine operator or social network provider into the hardware platform(s) of a computing environment or other system implementing a computing environment or similar functionalities in connection with social networking behaviors. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the system and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method, implemented on a machine having at least one processor, a storage device, and a communication platform connected to a network, for influencing a user's social networking contacts' decisions by utilizing social media comprising:
detecting, via the at least one processor, a transaction of the user;
interfacing, via the communications platform, with the user's social networking contacts;
sharing the user's transaction with the user's social networking contacts; and
gathering information related to the sharing.

2. The method of claim 1 where the transaction is at least one of the following:
a donation, an in-person conversion, and an on-line conversion.

3. The method of claim 1 wherein the interfacing occurs at the time of the transaction.

4. The method of claim 3 wherein the interface is accomplished via at least one of the following:
a point of sale device, a computer, a smartphone, a tablet, a portable communications device, a proprietary device, and a card reader device.

5. The method of claim 1 comprising:
issuing a record to the user of the transaction at the time of the transaction that allows the user to share the user's transaction via the communications platform at a time after the transaction.

6. A method, implemented on a machine having at least one processor, a storage device, and a communication platform connected to a network, for engaging a user to share a conversion with a provider, with the user's social networking contacts via a social media network comprising:
detecting, via the at least one processor, the completion of the conversion of the user;
launching, via the processor, an application on a user device interfacing, via the communications platform, with the user's social networking contacts;
sharing information about the user's conversion with the user's social networking contacts; and
gathering information related to the sharing.

7. The method of claim 6 where the application stores information about the conversion, prompts the user for second information, and communicates third information to the processor.

8. The method of claim 7 where the information is a cookie, an executable, or a link.

9. The method of claim 7 where the stored information has a built in preset expiration date.

10. The method of claim 7 where the second information relates to a goal set by the user and the user's social network.

11. The method of claim 7 where the third information is conveyed via the network to a third party and wherein the third information is at least one of the following:
a provider identifier, a conversion amount, and a conversion identifier.

12. The method of claim 10 where the goal set by the user is the shared information.

13. The method of claim 6 comprising;
providing a unique conversion identifier to a social network contact;
monitoring if the social network contact selects the unique conversion identifier;
directing the social network contact to the provider;
prompting the social network contact to complete a conversion.

14. The method of claim 13 wherein the unique conversion identifier directs the social network contact to a third party location and information related to the user's conversion is written to a device of the social network contact.

15. The method of claim 13 comprising;
determining if the social network contact completes a second conversion.

16. The method of claim 15 where if it is determined that the second conversion occurs,
a social network contact information is conveyed to a third party via the communications platform, and
wherein the social network contact information relates to the second conversion.

17. The method of claim 16 wherein the secondary conversion is associated with the user.

18. A method implemented on a machine having at least one processor, a storage device, and a communication platform connected to a network, for tracking a user's influence over subsequent users, comprising:
detecting, via the at least one processor, an action of the user;
interfacing, via the communications platform, with subsequent user's from the user's social networks;
distributing, via the communications platform, an application to the subsequent user's, in response to the user's action;
tracking the effects of the user's action on the subsequent user's;
gathering information related to the tracking.

19. The method of claim 18 where the gathering relates to the ripple effect of the user's action.

20. The method of claim 18 wherein the action is a selection of content.
